(19) United States
(12) Patent Application Publication
(10) Pub. No.: US 2022/0217973 A1
(43) Pub. Date: Jul. 14, 2022

(54) HIGH SPREADING AND UPTAKE ULV FORMULATIONS

(71) Applicant: Bayer Aktiengesellschaft, Leverkusen (DE)

(72) Inventors: Malcolm FAERS, Düsseldorf (DE); Amo RATSCHINSKI, Düsseldorf (DE); Gorka PERIS URQUIJO, Köln (DE); Emilia HILZ, Haan (DE); Sybille LAMPRECHT, Leverkusen (DE)

(73) Assignee: Bayer Aktiengesellschaft, Leverkusen (DE)

(21) Appl. No.: 17/595,083

(22) PCT Filed: May 8, 2020
(86) PCT No.: PCT/EP2020/062916

§ 371 Date: Nov. 8, 2021

(30) Foreign Application Priority Data
May 8, 2019 (EP) 19173402.9
May 8, 2019 (EP) 19173403.7
May 8, 2019 (EP) 19173404.5

(51) Int. Cl. A01N 25/04; A01N 25/30

(52) U.S. Cl. CPC A01N 25/04; A01N 25/06; A01N 25/30

(57) ABSTRACT

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

Modern agriculture faces many challenges in producing sufficient food in a safe and sustainable way. There is therefore a need to utilise crop protection products to enhance the safety, quality and yield while minimising the impact to the environment and agricultural land. Many crop protection products, whether chemical or biological, are normally applied at relatively high spray volumes, for example in selected cases >50 L/ha, and often >150-400 L/ha. A consequence of this is that much energy must be expended to carry the high volume of spray liquid and then apply it to the crop by spray application. This can be performed by large tractors which on account of their weight and also the weight of the spray liquid produce CO₂ from the mechanical work involved and also cause detrimental compaction of the soil, affecting root growth, health and yield of the plants, as well as the energy subsequently expended in remediating these effects.

There is a need for a solution that significantly reduces the high volumes of spray liquid and reduces the weight of the equipment required to apply the product.

In agriculture, low spray volume application technologies including unmanned aerial systems (UAS), unmanned guided vehicles (UGV), and tractor mounted boom sprayers fitted with pulse width modulation spray nozzles or rotating disc droplet applicators are offering farmers solutions to apply products with low spray volumes, typically down to 10 to 20 l/ha or less. These solutions have advantages including for example that they require significantly less water which is important in regions where the supply of water is limited, require less energy to transport and apply the spray liquid, are faster both from quicker filling of the spray tank and faster application, reduce the CO₂ generation from both the reduced volume of spray liquid to transport and from the use of smaller and lighter vehicles, reduced soil compaction damage, and enabling the use of cheaper application systems.

However, Wang et al [Field evaluation of an unmanned aerial vehicle (UAV) sprayer: effect of spray volume on deposition and the control of pests and disease in wheat. Pest Management Science 2019 doi/epdf/10.1002/ps.5321] demonstrated that as the spray volume is decreased from 450 and 225 l/ha to 28.1, 16.8 and 9.0 l/ha, the coverage (% area), number of spray deposits per area, and diameter of the spray deposits as measured on water sensitive paper all decreased (see Table 3 in Wang et al, 2019). In parallel, the biological control efficacy for both wheat aphid control and powdery mildew control decreased at low spray volumes with the greatest decrease observed at 9.0 l/ha, followed by 16.8 l/ha (see FIGS. 6, 7 and 8 in Wang et al, 2019).

There is therefore a need to design formulation systems that overcome the reduction in the coverage and diameter of the spray deposits at low spray volumes even through the number of spray deposits per area is decreasing: as the spray volume decreases, the number of spray droplets per unit area decreases proportionately for the same spray droplet spectra size. This is especially necessary below 25 l/ha, more especially below 17 l/ha, and even more especially at 10 l/ha and below.

Moreover, due to the decrease in spray volume and the number of spray droplets, it has to be made sure that the amount of active ingredient applied is actually available for the plant. This can be achieved by increasing the uptake of active ingredient into the plant.

Therefore, there is a need to provide formulations which, when sprayed at ultra-low spray volumes according to the present invention, show a good coverage of the crops to provide good biological efficacy while at the same time have an improved or at least acceptable uptake in combination with the improved spreading.

The solution is provided by formulations containing specific spreading agents at specific concentrations. Such formulations give increased coverage and increased diameter of spray deposits at low spray volumes. Furthermore, the increased coverage and increased diameter of spray deposits is comparable to the coverage obtained at normal higher spray volumes. Furthermore, the formulations exemplifying the invention are particularly effective on hard to wet leaf surfaces where more conventional spray volumes have poor retention and coverage.

A particular advantage of the invention stemming from the low total amount of organosilicone-based surfactant compared to the level required at normal higher spray volumes is lower cost of formulations and their ease of production. Further advantages include improved formulation stability and simplified manufacture, less cost of goods as well as less impact on the environment.

Formulations, also for tank mixes, known in the prior art containing spreading agents are principally designed for much higher spray volumes and generally contain lower concentrations of spreading agents in the spray broth. Nevertheless, due to the high spray volumes used in the prior art, the total amount of spreading agents used and therefore in the environment is higher than according to the present invention.

The concentration of the spreading agents is an important element of the invention, since suitable spreading occurs when a certain minimum concentration of spreading agents is achieved, normally 0.05% w/w or w/v (these are equivalent since the density of the spreading agents is approximately 1.0 g/cm³.

Therefore, in a spray volume of 500 l/ha as it is used in the prior art, about 250 g/ha of spreading agents would be required to achieve suitable spreading. Hence, faced with the task to reduce the spray volume, the skilled person would apply the same concentration of spreading agents in the formulation. For example, for a spray volume of 10 l/ha about 5 g/ha (about 0.05% in the spray broth) surfactant would be required. However, at such a low volume with such low concentration of spreading agents sufficient spreading cannot be achieved (see examples).

Moreover, as pointed out above, according to the present invention, uptake enhancers have to be present to enable uptake of the active ingredients into the plants to enhance biological efficacy.

In this invention, we have surprisingly found that increasing the concentration of spreading agents as the spray volume decreases can compensate for the loss in coverage (due to insufficient spreading) from the reduction in spray volume. It was surprisingly found that for every reduction of the spray volume by 50%, the concentration of surfactant should roughly be doubled.

Thus, although the absolute concentration of the spreading agents is increased compared to formulations known in the art, the relative total amount per ha can be decreased, which is advantageous, both economically and ecologically, while coverage by and efficacy of the formulation according to the invention is improved, maintained or at least kept at an acceptable level when other benefits of the low volume applications are considered, e.g. less costs of formulation due to less cost of goods, smaller vehicles with less working costs, less compacting of soil etc.

Further, we have surprisingly found that the formulations according to the present invention show an comparable or enhanced uptake of active ingredient when compared to formulations with higher spray volumes known in the art.

A further part of the invention that allows surprising low total amount of spreading agents to be used is the surface texture of the target crop leaves. Bico et al [Wetting of textured surfaces, Colloids and Surfaces A, 206 (2002) 41-46] have established that compared to smooth surfaces, textured surfaces can enhance the wetting for formulation spray dilutions with contact angles <90° and reduce the wetting for contact angles >90°.

This is also the case for leaf surfaces, in particular textured leaf surfaces, when sprayed in a method according to the invention resulting in low total amounts (per ha) of spreading agents due to the low spray volumes with formulations according to the invention having a high concentration of the spreading agents. Remarkably high coverage of the leaf surfaces by the spray liquid, even to a level greater than would be normally be expected, could be demonstrated.

Textured leaf surfaces include leaves containing micron-scale wax crystals on the surface such as wheat, barley, rice, rapeseed, soybean (young plants) and cabbage for example, and leaves with surface textures such as lotus plant leaves for example. The surface texture can be determined by scanning electron microscope (SEM) observations and the leaf wettability determined by measuring the contact angle made by a drop of water on the leaf surface.

In summary, the object of the present invention is to provide a formulation which can be applied in ultra-low volumes, i.e. <20 l/ha, while still providing good leaf coverage, uptake and biological efficacy against fungicidal pathogens, weeds and pests and at the same time reducing the amounts of additional additives applied per ha, as well as a method of using said formulation at ultra-low volumes (<20 l/ha), and the use of said formulation for application in ultra-low volumes as defined above.

While the application on textured leaves is preferred, surprisingly it was found that also on non-textured leaves the formulations according to the instant invention showed good spreading and coverage as well as other properties compared to classical spray application formulations for 200 l/ha.

In one aspect, the present invention is directed to the use of the compositions according to the invention for foliar application.

If not otherwise indicated, % in this application means percent by weight (% w/w).

It is understood that in case of combinations of various components, the percentages of all components of the formulations always sum up to 100.

Further, if not otherwise indicated, the reference “to volume” for water indicates that water is added to a total volume of a formulation of 1000 ml (11). For the sake of clarity it is understood that if unclear the density of the formulation is understood as to be 1 g/cm³.

In the context of the present invention aqueous based agrochemical compositions comprise at least 5% of water and include suspension concentrates, aqueous suspensions, suspo-emulsions or capsule suspensions, preferably suspension concentrates and aqueous suspensions.

Further, it is understood, that the preferred given ranges of the application volumes or application rates as well as of the respective ingredients as given in the instant specification can be freely combined and all combinations are disclosed herein, however, in a more preferred embodiment, the ingredients are preferably present in the ranges of the same degree of preference, and even more preferred the ingredients are present in the most preferred ranges.

In one aspect, the invention refers to a formulation comprising:
a) One or more active ingredients,
b) One or more spreading agents,
c) One or more uptake enhancer,
d) Other formulants,
e) one or more carriers to volume (1 L or 1 kg),
   wherein b) is present in 5 to 150 g/l.

If not otherwise indicated in the present invention the carrier is usually used to volume the formulation. Preferably, the concentration of carrier in the formulation according to the invention is at least 5% w/w, more preferred at least 10% w/w such as at least 20% w/w, at least 40% w/w, at least 50% w/w, at least 60% w/w, at least 70% w/w and at least 80% w/w or respectively at least 50 g/l, more preferred at least 100 g/l such as at least 200 g/l, at least 400 g/l, at least 500 g/l, at least 600 g/l, at least 700 g/l and at least 800 g/l.

The formulation is preferably a spray application to be used on crops.

In a preferred embodiment according to the present invention, also for the following embodiments in the specification, the carrier is water.

In a preferred embodiment the formulation of the instant invention comprises
a) One or more active ingredients,
b) One or more spreading agents,
c) One or more uptake enhancer,
d1) At least one suitable non-ionic surfactant and/or suitable ionic surfactant.,
d2) Optionally, a rheological modifier,
d3) Optionally, a suitable antifoam substance,
d4) Optionally, suitable antifreeze agents,
d5) Optionally, suitable other formulants.
e) carrier to volume,
wherein b) is present in 5 to 150 g/l, and wherein water is even more preferred as carrier.
In another embodiment at least one of d2, d3, d4 and d5 are mandatory, preferably, at least two of d2, d3, d4 and d5 are mandatory, and in yet another embodiment d2, d3, d4 and d5 are mandatory.
In a preferred embodiment component a) is preferably present in an amount from 5 to 300 g/l, preferably from 10 to 250 g/l, and most preferred from 20 to 210 g/l.
In an alternative embodiment component a) is a fungicide.
In an alternative embodiment component a) is an insecticide.
In an alternative embodiment component a) is a herbicide.
In a preferred embodiment component b) is present in 5 to 150 g/l, preferably from 10 to 120 g/l, and most preferred from 15 to 110 g/l.
In a preferred embodiment component c) is present in 10 to 150 g/l, preferably from 25 to 120 g/l, and most preferred from 30 to 110 g/l.
In a preferred embodiment component d) is present in 5 to 250 g/l, preferably from 10 to 150 g/l, and most preferred from 20 to 120 g/l.
In a preferred embodiment the one or more component d1) is present in 4 to 250 g/l, preferably from 8 to 120 g/l, and most preferred from 10 to 80 g/l.
In a preferred embodiment the one or more component d2) is present in 0 to 60 g/l, preferably from 1 to 20 g/l, and most preferred from 2 to 10 g/l.
In a preferred embodiment the one or more component d3) is present in 0 to 30 g/l, preferably from 0.5 to 20 g/l, and most preferred from 1 to 12 g/l.
In a preferred embodiment the one or more component d4) is present in 0 to 200 g/l, preferably from 5 to 150 g/l, and most preferred from 10 to 120 g/l.
In a preferred embodiment the one or more component d5) is present in 0 to 200 g/l, preferably from 0.1 to 120 g/l, and most preferred from 0.5 to 80 g/l.

In one embodiment the formulation comprises the components a) to e) in the following amounts
a) from 5 to 300 g/l, preferably from 10 to 250 g/l, and most preferred from 20 to 210 g/l,
b) from 5 to 150 g/l, preferably from 10 to 120 g/l, and most preferred from 15 to 110 g/l,
c) from 10 to 150 g/l, preferably from 25 to 120 g/l, and most preferred from 30 to 110 g/l,
d) from 5 to 250 g/l, preferably from 10 to 150 g/l, and most preferred from 20 to 120 g/l,
e) carrier to volume,
wherein the carrier is preferably water.

In another embodiment the formulation comprises the components a) to e) in the following amounts
a) from 5 to 300 g/l, preferably from 10 to 250 g/l, and most preferred from 20 to 210 g/l,
b) from, 5 to 150 g/l, preferably from 10 to 120 g/l, and most preferred from 15 to 110 g/l,
c) from 10 to 150 g/l, preferably from 25 to 120 g/l, and most preferred from 30 to 110 g/l,
d1) from 4 to 250 g/l, preferably from 8 to 120 g/l, and most preferred from 10 to 80 g/l,
d2) from 0 to 60 g/l, preferably from 1 to 20 g/l, and most preferred from 2 to 10 g/l,
d3) from 0 to 30 g/l, preferably from 0.5 to 20 g/l, and most preferred from 1 to 12 g/l,
d4) from 0 to 200 g/l, preferably from 5 to 150 g/l, and most preferred from 10 to 120 g/l,
d5) from 0 to 200 g/l, preferably from 0.1 to 120 g/l, and most preferred from 0.5 to 80 g/l,
e) carrier to volume, wherein the carrier is preferably water.

It is understood that in case a solid carrier is used, the above referenced amounts refer to 1 kg instead of to 1 l, i.e. g/kg.

As indicated above, component d) is always added to volume, i.e. to 1 l or 1 kg.

In a further preferred embodiment of the present invention the formulation consists only of the above described ingredients a) to e) in the specified amounts and ranges.

In a preferred embodiment the herbicide is used in combination with a safener, which is preferably selected from the group comprising isoxadifen-ethyl and mefenpyr-diethyl.

The instant invention further applies to a method of application of the above referenced formulations, wherein the formulation is applied at a spray volume of between 1 and 20 l/ha, preferably 2 and 15 l/ha, more preferably 5 and 15 l/ha.

More preferred, the instant invention applies to a method of application of the above referenced formulations, wherein the formulation is applied at a spray volume of between 1 and 20 l/ha, preferably 2 and 15 l/ha, more preferably 5 and 15 l/ha, and the amount of b) from 5 to 150 g/l, preferably from 10 to 120 g/l, and most preferred from 15 to 110 g/l, wherein in a further preferred embodiment a) is present from from 5 to 300 g/l, preferably from 10 to 250 g/l, and most preferred from 20 to 210 g/l, and even further preferred c) is present in an amount from 10 to 150 g/l, preferably from 25 to 120 g/l, and most preferred from 30 to 80 g/l.

In another aspect the instant invention applies to a method of application of the above referenced formulations,

wherein the formulation is applied at a spray volume of between 1 and 20 l/ha, preferably 2 and 15 l/ha, more preferably 5 and 15 l/ha, and

wherein preferably the applied amount of a) to the crop is between 2 and 150 g/ha, preferably between 5 and 120 g/ha, and more preferred between 20 and 100 g/ha.

Further, the spreading agent b) is preferably applied from 5 g/ha to 150 g/ha, more preferably from 7.5 g/ha to 100 g/ha, and most preferred from 10 g/ha to 60 g/ha.

Further, the uptake enhancer c) is preferably applied from 5 g/ha to 150 g/ha, more preferably from 7.5 g/ha to 100 g/ha, and most preferred from 10 g/ha to 60 g/ha.

In one embodiment, the with the above indicated method applied amount of a) to the crop is between 2 and 10 g/ha.

In another embodiment, the with the above indicated method applied amount of a) to the crop is between 40 and 110 g/ha.

In one embodiment in the applications described above, the active ingredient (ai) a) is preferably applied from 2 and 150 g/ha, preferably between 5 and 120 g/ha, and more preferred between 20 and 100 g/ha, while correspondingly the spreading agent is preferably applied from 10 g/ha to 100 g/ha, more preferably from 20 g/ha to 80 g/ha, and most preferred from 40 g/ha to 60 g/ha.

In particular the formulations of the instant invention are useful for application with a spray volume of between 1 and 20 l/ha, preferably 2 and 15 l/ha, more preferably 5 and 15 l/ha on plants or crops with textured leaf surfaces, preferably on wheat, barley, rice, rapeseed, soybean (young plants) and cabbage.

Further, the instant invention refers to a method of treating crops with textured leaf surfaces, preferably wheat, barley, rice, rapeseed, soybean (young plants) and cabbage, with with a spray volume of between 1 and 20 l/ha, preferably 2 and 15 l/ha, more preferably 5 and 15 l/ha.

In a preferred embodiment the above described applications are applied on crops with textured leaf surfaces, preferably on wheat, barley, rice, rapeseed, soybean (young plants) and cabbage.

In one embodiment the active ingredient is a fungicide or a mixture of two fungicides or a mixture of three fungicides.

In another embodiment the active ingredient is an insecticide or a mixture of two insecticides or a mixture of three insecticides.

In yet another embodiment the active ingredient is a herbicide or a mixture of two herbicides or a mixture of three herbicides, wherein preferably in the mixtures on mixing partner is a safener. The corresponding doses of spreading agent (b) in formulations according to the invention to the applied doses are:

A 2 l/ha liquid formulation delivering
50 g/ha of spreading agent contains 25 g/l of surfactant (b).
30 g/ha of spreading agent contains 15 g/l of surfactant (b).
12 g/ha of spreading agent contains 6 g/l of surfactant (b).
10 g/ha of spreading agent contains 5 g/l of surfactant (b).

A 1 l/ha liquid formulation delivering:
50 g/ha of spreading agent contains 50 g/l of surfactant (b),
30 g/ha of spreading agent contains 30 g/l of surfactant (b),
12 g/ha of spreading agent contains 12 g/l of surfactant (b),
10 g/ha of spreading agent contains 10 g/l of surfactant (b).

A 0.5 l/ha liquid formulation delivering:
50 g/ha of spreading agent contains 100 g/l of surfactant (b),
30 g/ha of spreading agent contains 60 g/l of surfactant (b),
12 g/ha of spreading agent contains 24 g/l of surfactant (b),
10 g/ha of spreading agent contains 20 g/l of surfactant (b).

A 0.2 l/ha liquid formulation delivering:
50 g/ha of spreading agent contains 250 g/l of surfactant (b),
30 g/ha of spreading agent contains 150 g/l of surfactant (b),
12 g/ha of spreading agent contains 60 g/l of surfactant (b),
10 g/ha of spreading agent contains 50 g/l of surfactant (b).

A 2 kg/ha solid formulation delivering:
50 g/ha of spreading agent contains 25 g/kg of surfactant (b),
30 g/ha of spreading agent contains 15 g/kg of surfactant (b),
12 g/ha of spreading agent contains 6 g/kg of surfactant (b),
10 g/ha of spreading agent contains 5 g/kg of surfactant (b).

A 1 kg/ha solid formulation delivering:
50 g/ha of spreading agent contains 50 g/kg of surfactant (b),
30 g/ha of spreading agent contains 30 g/kg of surfactant (b),
12 g/ha of spreading agent contains 12 g/kg of surfactant (b),
10 g/ha of spreading agent contains 10 g/kg of surfactant (b).

A 0.5 kg/ha solid formulation delivering:
50 g/ha of spreading agent contains 100 g/kg of surfactant (b),
30 g/ha of spreading agent contains 60 g/kg of surfactant (b),
12 g/ha of spreading agent contains 24 g/kg of surfactant (b),
10 g/ha of spreading agent contains 20 g/kg of surfactant (b).

The concentrations of spreading agent (b) in formulations that are applied at other dose per hectare rates can be calculated in the same way.

In the context of the present invention, suitable formulation types are by definition suspension concentrates, aqueous suspensions, suspo-emulsions or capsule suspensions, emulsion concentrates, water dispersible granules, oil dispersions, emulsifiable concentrates, dispersible concentrates, wettable granules, preferably suspension concentrates, aqueous suspensions, suspo-emulsions and oil dispersions, wherein in the case of non-aqueous formulations or solid formulations the sprayable formulation are obtained by adding water.

Active Ingredients (a):

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current IRAC Mode of Action Classification Scheme at the time of filing of this patent application.

Examples of fungicides (a) according to the invention are:

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chloro-cyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-((2R,4S)-2-[2-chloro-4-(4-chlorophenoxy)phenyl]-4-methyl-1,3-dioxolan-2-yl methyl)-1H-1,2,4-triazole, (1.038) 1-((2S,4S)-2-[2-chloro-4-(4-chlorophenoxy)phenyl]-4-methyl-1,3-dioxolan-2-yl methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl-1H-1,2,4-triazol-5-yl thiocyanate, (1.041) 1-{[rel(2R,3S)-3-(2-chlorophenyl)-2-(2,4-difluorophenyl)oxiran-2-yl]methyl-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichloro-phenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) mefentrifluconazole, (1.056) 2-{[3-(2-chlorophenyl)-2-(2,4-difluorophenyl)oxiran-2-yl]methyl-2,4-dihydro-3H-1,2,4-triazole-3-thione, (1.057) 2-{[rel(2R,3R)-3-(2-chlorophenyl)-2-(2,4-difluoro-phenyl)oxiran-2-yl]methyl-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]-phenoxy}phenyl)-N-ethyl-N-methylimidoformamide, (1.068) N′-(2,5-dimethyl-4-{3-[(2,2,2-trifluoro-ethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimido-formamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropyl-cyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimido-formamide, (1.081) ipfentrifluconazole, (1.082) 2-[4-(4-chlorophenoxy)-2-(trifluoromethyl)phenyl]-1-(1H-1,2,4-triazol-1-yl)propan-2-ol, (1.083) 2-[6-(4-bromophenoxy)-2-(trifluoromethyl)-3-pyridyl]-1-(1,2,4-triazol-1-yl)propan-2-ol, (1.084) 2-[6-(4-chlorophenoxy)-2-(trifluoromethyl)-3-pyridyl]-1-(1,2,4-triazol-1-yl)propan-2-ol, (1.085) 3-[2-(1-chlorocyclopropyl)-3-(3-chloro-2-fluoro-phenyl)-2-hydroxy-propyl]imidazole-4-carbonitrile, (1.086) 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile, (1.087) N-isopropyl-N′-[5-methoxy-2-methyl-4-(2,2,2-trifluoro-1-hydroxy-1-phenylethyl)phenyl]-N-methylimidoformamide, (1.088) N′-{5-bromo-2-methyl-6-[(1-propoxypropan-2-yl)oxy]pyridin-3-yl}-N-ethyl-N-methylimido-formamide, (1.089) hexaconazole, (1.090) penconazole, (1.091) fenbuconazole.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)-pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne, (2.058) N-[rac-(1S,2S)-2-(2,4-dichlorophenyl)cyclobutyl]-2-(trifluoromethyl)-nicotinamide, (2.059) N-[(1S,2S)-2-(2,4-dichlorophenyl)cyclobutyl]-2-(trifluoromethyl)nicotinamide.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.

4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) pyridachlometyl, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine, (4.026) fluopimomide.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper (2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable to induce a host defence, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) tolprocarb.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Further fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)-phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoro-methyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) ipflufenoquin, (15.042) 2-{2-fluoro-6-[(8-fluoro-2-methylquinolin-3-yl)oxy]phenyl}propan-2-ol, (15.043) fluoxapiprolin, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]-pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimido-formamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) methyl {4-[5-(trifluoromethyl)-1,2,4-oxadiazol-3-yl]phenyl}carbamate, (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyimino-methyl]-4-[5-(trifluoromethyl)-1,2,4-oxadiazol-3-yl]benzamide, (15.078) N—[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoro-methyl)-1,2,4-oxadiazol-3-yl]benzamide, (15.084) N—[(Z)—N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoro-methyl}-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phen-yl]methyl]propanamide, (15.093) N-methoxy-N-[[4-[5-(trifluoromethyl)-1,2,4-oxadiazol-3-yl]phenyl]-methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[[4-[5-(trifluoromethyl}-1,2,4-oxadiazol-3-yl]phenyl]methyl]propanamide, (15.097) N-ethyl-2-methyl-N-[[4-[5-(trifluoromethyl)-1,2,4-oxadiazol-3-yl)phenyl]methyl]propanamide, (15.098) 1-methoxy-3-methyl-1-[[4-[5-(trifluoro-methyl)-1,2,4-oxadiazol-3-yl]phenyl]methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]-methyl]piperidin-2-one, (15.102) 4,4-dimethyl-2-[[4-[5-(trifluoromethyl)-1,2,4-oxadiazol-3-yl]phenyl]-methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]-phenyl]methyl]azepan-2-one, (15.106) 4,4-dimethyl-2-[[4-(5-(trifluoromethyl)-1,2,4-oxadiazol-3-yl]-phenyl]methyl]isoxazolidin-3-one, (15.107) 5,5-dimethyl-2-[[4-[5-(trifluoromethyl)-1,2,4-oxadiazol-3-yl]phenyl]methyl]isoxazolidin-3-one, (15.108) ethyl 1-{4-[5-(trifluoromethyl)-1,2,4-oxadiazol-3-yl]benzyl}-1H-pyrazole-4-carboxylate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydro-isoquinoline, (15.115) 1-(5-(fluoromethyl)-6-methyl-pyridin-3-yl)-4,4-difluoro-3,3-dimethyl-3,4-dihydroisoquinoline, (15.116) 1-(6-(difluoromethyl)-5-methoxy-pyridin-3-yl)-4,4-difluoro-3,3-dimethyl-3,4-dihydroisoquinoline, (15.117) 4-[5-(trifluoromethyl)-1,2,4-oxadiazol-3-yl]phenyl dimethyl-carbamate, (15.118) N-{4-[5-(trifluoromethyl)-1,2,4-oxadiazol-3-yl]phenyl}propanamide, (15.119) 3-[2-(1-1 [5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.120) 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.121) 3-[2-(1-{[3,5-bis(difluoromethyl)-1H-pyrazol-1-yl]acetyl}piperidin-4-yl)-1,3-thiazol-4-yl]-1,5-dihydro-2,4-benzodioxepin-6-yl methanesulfonate, (15.122) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2,4-benzodioxepin-6-yl methanesulfonate, (15.123) 1-(6,7-dimethylpyrazolo[1,5-a]pyridin-3-yl)-4,4-difluoro-3,3-dimethyl-3,4-dihydroisoquinoline, (15.124) 8-fluoro-N-(4,4,4-trifluoro-2-methyl-1-phenylbutan-2-yl)quinoline-3-carboxamide, (15.125) 8-fluoro-N-[(2S)-4,4,4-trifluoro-2-methyl-1-phenylbutan-2-yl]quinoline-3-carboxamide, (15.126) N-(2,4-dimethyl-1-phenylpentan-2-yl)-8-fluoroquinoline-3-carboxamide and (15.127) N-[(2S)-2,4-dimethyl-1-phenylpentan-2-yl]-8-fluoroquinoline-3-carboxamide.

Examples of insecticides (a) according to the invention are:

(1) Acetylcholinesterase (AChE)-inhibitors, e.g. Carbamates Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC andan Xylylcarb, or organophosphates, e.g. Acephat, Azamethiphos, Azinphos-ethyl, Azinphos-methyl, Cadusafos, Chlorethoxyfos, Chlorfenvinphos, Chlormephos, Chlorpyrifos-methyl, Coumaphos, Cyanophos, Demeton-S-methyl, Diazinon, Dichlorvos/DDVP, Dicrotophos, Dimethoat, Dimethylvinphos, Disulfoton, EPN, Ethion, Ethoprophos, Famphur, Fenamiphos, Fenitrothion, Fenthion, Fosthiazat, Heptenophos, Imicyafos, Isofenphos, Isopropyl-O-(methoxyaminothio-phosphoryl)salicylat, Isoxathion, Malathion, Mecarbam, Methamidophos, Methidathion, Mevinphos, Monocrotophos, Naled, Omethoate, Oxydemeton-methyl, Parathion-methyl, Phenthoat, Phorat, Phosalon, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Triclorfon andand Vamidothion.

(2) GABA-gated chloride channel antagonists, preferably Cyclodien-organochlorine selected from the group of Chlordan and Endosulfan, or Phenylpyrazole (Fiprole) selected from Ethiprol and Fipronil.

(3) Sodium channel modulators/voltage-dependent sodium channel blockers, for example pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(1R) isomers), Esfenvalerate, Etofenprox, Fenpropathrin, Fenvalerate, Flucythrinate, Flumethrin, tau-Fluvalinate, Halfenprox, Imiprothrin, Kadethrin, Momfluorothrin, Permethrin, Phenothrin [(1R)-trans isomer), Prallethrin, Pyrethrine (pyrethrum), Resmethrin, Silafluofen, Tefluthrin, Tetramethrin, Tetramethrin [(1R) isomers)], Tralomethrin and Transfluthrin or DDT or Methoxychlor.

(4) Nicotinic acetylcholine receptor (nAChR) competitive activators, preferably Neonicotinoids selected from Acetamiprid, Clothianidin, Dinotefuran, Imidacloprid, Nitenpyram, Thiacloprid and Thiamethoxam, or Nicotin, or Sulfoximine selected from Sulfoxaflor, or Butenolide selected from Flupyradifurone, or Mesoionics selected from Triflumezopyrim.

(5) Nicotinic acetylcholine receptor (nAChR) allosteric activators, preferably Spinosynes selected from Spinetoram and Spinosad.

(6) Allosteric modulators of the glutamate-dependent chloride channel (GluCl), preferablyAvermectine/Milbemycine selected from Abamectin, Emamectin-benzoate, Lepimectin and Milbemectin.

(7) Juvenile hormone mimetics, preferably Juvenile hormon-analogs selected from Hydropren, Kinopren and Methopren, or Fenoxycarb or Pyriproxyfen.

(8) Various non-specific (multi-site) inhibitors, preferably Alkylhalogenides selected from Methylbromide and other Alkylhalogenides, or Chloropicrin or Sulfurylfluorid or Borax or Tartar emetic or Methylisocyanate generators selected from Diazomet and Metam.

(9) TRPV channel modulators of chordotonal organs selected from Pymetrozin and Pyrifluquinazon.

(10) Mite growth inhibitors selected from Clofentezin, Hexythiazox, Diflovidazin and Etoxazol.

(11) Microbial disruptors of the insect intestinal membrane selected from Bacillus thuringiensis Subspezies israelensis, Bacillus sphaericus, Bacillus thuringiensis Subspezies aizawai, Bacillus thuringiensis Subspezies kurstaki, Bacillus thuringiensis subspecies tenebrionis and B.t.-plant proteins selected from Cry1Ab, Cry1Ac, Cry1Fa, Cry1A.105, Cry2Ab, VIP3A, mCry3A, Cry3Ab, Cry3Bb and Cry34Ab1/35Ab1.

(12) Mitochondrial ATP synthase inhibitors, preferably ATP-disruptors selected from Diafenthiuron, or Organo-tin-compoiunds selected from Azocyclotin, Cyhexatin and Fenbutatin-oxid, or Propargit or Tetradifon.

(13) Decoupler of oxidative phosphorylation by disturbance of the proton gradient selected from Chlorfenapyr, DNOC and Sulfluramid.

(14) Nicotinic acetylcholine receptor channel blocker selected from Bensultap, Cartap-hydrochlorid, Thiocyclam and Thiosultap-Sodium.

(15) Inhibitors of chitin biosynthesis, Typ 0, selected from Bistrifluron, Chlorfluazuron, Diflubenzuron, Flucycloxuron, Flufenoxuron, Hexaflumuron, Lufenuron, Novaluron, Noviflumuron, Teflubenzuron and Triflumuron.

(16) Inhibitors of chitin biosynthesis, Typ 1 selected from Buprofezin.

(17) Molting disruptor (especially dipteras, i.e. two-winged insects) selected from Cyromazin.

(18) Ecdyson receptor agonists selected from Chromafenozid, Halofenozid, Methoxyfenozid and Tebufenozid.

(19) Octopamin-receptor-agonists selected from Amitraz.

(20) Mitochondrial complex III electron transport inhibitors selected from Hydramethylnon, Acequinocyl and Fluacrypyrim.

(21) Mitochondrial complex I electron transport inhibitors, preferably so-called METI-acaricides selected from Fenazaquin, Fenpyroximat, Pyrimidifen, Pyridaben, Tebufenpyrad and Tolfenpyrad, or Rotenon (Derris).

(22) Blocker of the voltage-dependent sodium channel selected from Indoxacarb and Metaflumizone.

(23) Inhibitors of acetyl-CoA carboxylase, preferably tetronic and tetramic acid derivatives selected from Spirodiclofen, Spiromesifen, Spirotetramat and Spidoxamate (IUPAC Name: 11-(4-chloro-2,6-xylyl)-12-hydroxy-1,4-dioxa-9-azadispiro[4.2.4.2]tetradec-11-en-10-one).

(24) Mitochondrial complex IV electron transport inhibitors, preferably Phosphines selected from Aluminiumphosphid, Calciumphosphid, Phosphin and Zinkphosphid, or Cyanides selected from Calciumcyanid, Potassiumcyanid and Sodiumcyanid.

(25) Mitochondrial complex II electron transport inhibitors, preferablybeta-Ketonitrilderivate selected from Cyenopyrafen and Cyflumetofen, or Carboxanilide selected from Pyflubumid.

(28) Ryanodinreceptor-modulators, preferably Diamide selected from Chlorantraniliprol, Cyantraniliprol and Flubendiamid.

(29) Modulators of chordotonal organs (with undefined target structure) selected from Flonicamid.

(30) other active ingredients selected from Acynonapyr, Afidopyropen, Afoxolaner, Azadirachtin, Benclothiaz, Benzoximat, Benzpyrimoxan, Bifenazat, Broflanilid, Bromopropylat, Chinomethionat, Chloroprallethrin, Cryolit, Cyclaniliprol, Cycloxaprid, Cyhalodiamid, Dicloromezotiaz, Dicofol, Dimpropyridaz, epsilon-Metofluthrin, epsilon-Momfluthrin, Flometoquin, Fluazaindolizin, Fluensulfon, Flufenerim, Flufenoxystrobin, Flufiprol, Fluhexafon, Fluopyram, Flupyrimin, Fluralaner, Fluxametamid, Fufenozid, Guadipyr, Heptafluthrin, Imidaclothiz, Iprodione, Isocycloseram, kappa-Bifenthrin, kappa-Tefluthrin, Lotilaner, Meperfluthrin, Oxazosulfyl, Paichongding, Pyridalyl, Pyrifluquinazon, Pyriminostrobin, Spirobudiclofen, Spiropidion, Tetramethylfluthrin, Tetraniliprol, Tetrachlorantraniliprol, Tigolaner, Tioxazafen, Thiofluoximat and Iodmethan; products from Bacillus firmus (1-1582, BioNeem, Votivo), as well as following compounds: 1-{2-Fluor-4-methyl-5-[(2,2,2-trifluorethyl)sulfinyl]phenyl}-3-(trifluormethyl)-1H-1,2,4-triazol-5-amin (known from WO2006/043635) (CAS 885026-50-6), {1′-[(2E)-3-(4-Chlorphenyl)prop-2-en-1-yl]-5-fluorspiro[indol-3,4′-piperidin]-1(2H)-yl}(2-chlorpyridin-4-yl)methanon (known from WO2003/106457) (CAS 637360-23-7), 2-Chlor-N-[2-{1-[(2E)-3-(4-chlorphenyl)prop-2-en-1-yl]piperidin-4-yl}-4-(trifluormethyl)phenyl]isonicotinamid (known from WO2006/003494) (CAS 872999-66-1), 3-(4-Chlor-2,6-dimethylphenyl)-4-hydroxy-8-methoxy-1,8-diazaspiro[4.5]dec-3-en-2-on (known from WO 2010052161) (CAS 1225292-17-0), 3-(4-Chlor-2,6-dimethylphenyl)-8-methoxy-2-oxo-1,8-diazaspiro[4.5]dec-3-en-4-yl-ethylcarbonat (known from EP 2647626) (CAS-1440516-42-6), 4-(But-2-in-1-yloxy)-6-(3,5-dimethylpiperidin-1-yl)-5-fluoropyrimidin (known from WO2004/099160) (CAS 792914-58-0), PF1364 (known from JP2010/018586) (CAS-Reg. No. 1204776-60-2), (3E)-3-[1-[(6-Chlor-3-pyridyl)methyl]-2-pyridyliden]-1,1,1-trifluorpropan-2-on (known from WO2013/144213) (CAS 1461743-15-6), N-[3-(Benzylcarbamoyl)-4-chlorphenyl]-1-methyl-3-(pentafluorethyl)-4-(trifluormethyl)-1H-pyrazol-5-carboxamid (known from WO2010/051926) (CAS 1226889-14-0), 5-Brom-4-chlor-N-[4-chlor-2-methyl-6-(methylcarbamoyl)phenyl]-2-(3-chlor-2-pyridyl)pyrazol-3-carboxamid (known from CN103232431) (CAS 1449220-44-3), 4-[5-(3,5-Dichlorphenyl)-4,5-dihydro-5-(trifluormethyl)-3-isoxazolyl]-2-methyl-N-(cis-1-oxido-3-thietanyl)benzamid, 4-[5-(3,5-Dichlorphenyl)-4,5-dihydro-5-(trifluormethyl)-3-isoxazolyl]-2-methyl-N-(trans-1-oxido-3-thietanyl)benzamid and 4-[(5S)-5-(3,5-Dichlorphenyl)-4,5-dihydro-5-(trifluormethyl)-3-isoxazolyl]-2-methyl-N-(cis-1-oxido-3-thietanyl)benzamid (known from WO 2013/050317 A1) (CAS 1332628-83-7), N-[3-Chlor-1-(3-pyridinyl)-1H-pyrazol-4-yl]-N-ethyl-3-[(3,3,3-trifluorpropyl)sulfinyl]propanamid, (+)-N-[3-Chlor-1-(3-pyridinyl)-1H-pyrazol-4-yl]-N-ethyl-3-[(3,3,3-trifluorpropyl)sulfinyl]propanamid and (−)-N-[3-Chlor-1-(3-pyridinyl)-1H-pyrazol-4-yl]-N-ethyl-3-[(3,3,3-trifluorpropyl)sulfinyl]propanamid (known from WO 2013/162715 A2, WO 2013/162716 A2, US 2014/0213448 A1) (CAS 1477923-37-7), 5-[[(2E)-3-Chlor-2-propen-1-yl]amino]-1-[2,6-dichlor-4-(trifluormethyl)phenyl]-4-[(trifluormethyl)sulfinyl]-1H-pyrazol-3-carbonitrile (known from CN 101337937 A) (CAS 1105672-77-2), 3-Brom-N-[4-chlor-2-methyl-6-[(methylamino)thioxomethyl]phenyl]-1-(3-chlor-2-pyridinyl)-1H-pyrazol-5-carboxamid, (Liudaibenjiaxuanan, known from CN 103109816 A) (CAS 1232543-85-9); N-[4-Chlor-2-[[(1,1-dimethylethyl)amino]carbonyl]-6-methylphenyl]-1-(3-chlor-2-pyridinyl)-3-(fluormethoxy)-1H-pyrazol-5-carboxamid (known from WO 2012/034403 A1) (CAS 1268277-22-0), N-[2-(5-Amino-1,3,4-thiadiazol-2-yl)-4-chlor-6-methylphenyl]-3-brom-1-(3-chlor-2-pyridinyl)-1H-pyrazol-5-carboxamid (known from WO 2011/085575 A1) (CAS 1233882-22-8), 4-[3-[2,6-Dichlor-4-[(3,3-dichlor-2-propen-1-yl)oxy]phenoxy]propoxy]-2-methoxy-6-(trifluormethyl)pyrimidin (known from CN 101337940 A) (CAS 1108184-52-6); (2E)- and 2(Z)-2-[2-(4-Cyanophenyl)-1-[3-(trifluormethyl)phenyl]ethyliden]-N-[4-(difluormethoxy)phenyl]hydrazincarboxamid (known from CN 101715774 A) (CAS 1232543-85-9); Cyclopropancarbonsaure-3-(2,2-dichlorethenyl)-2,2-dimethyl-4-(1H-benzimidazol-2-yl)phenylester (known from CN 103524422 A) (CAS 1542271-46-4); (4aS)-7-Chlor-2,5-dihydro-2-[[(methoxycarbonyl)[4-[(trifluormethyl)thio]phenyl]amino]carbonyl]indeno[1,2-e][1,3,4]oxadiazin-4a(3H)-carbonsauremethylester (known from CN 102391261 A) (CAS 1370358-69-2); 6-Desoxy-3-O-ethyl-2,4-di-O-methyl-1-[N-[4-[1-[4-(1,1,2,2,2-pentafluorethoxy)phenyl]-1H-1,2,4-triazol-3-yl]phenyl]carbamat]-α-L-mannopyranose (known from US 2014/0275503 A1) (CAS 1181213-14-8); 8-(2-Cyclopropylmethoxy-4-trifluormethylphenoxy)-3-(6-trifluormethylpyridazin-3-yl)-3-azabicyclo[3.2.1]octan (CAS 1253850-56-4), (8-anti)-8-(2-Cyclopropylmethoxy-4-trifluormethylphenoxy)-3-(6-trifluormethylpyridazin-3-yl)-3-azabicyclo[3.2.1]octan (CAS 933798-27-7), (8-syn)-8-(2-Cyclopropylmethoxy-4-trifluormethylphenoxy)-3-(6-trifluormethylpyridazin-3-yl)-3-azabicyclo[3.2.1]octan (known from WO 2007040280 A1, WO 2007040282 A1) (CAS 934001-66-8), N-[3-Chlor-1-(3-pyridinyl)-1H-pyrazol-4-yl]-N-ethyl-3-[(3,3,3-trifluorpropyl)thio]-propanamid (known from WO 2015/058021 A1, WO 2015/058028 A1) (CAS 1477919-27-9) and N-[4-(Aminothioxomethyl)-2-methyl-6-[(methylamino)carbonyl]phenyl]-3-bromo-1-(3-chloro-2-pyridinyl)-1H-pyrazol-5-carboxamid (known from CN 103265527 A) (CAS 1452877-50-7), 5-(1,3-Dioxan-2-yl)-4-[[4-(trifluormethyl)phenyl]methoxy]-pyrimidin (known from WO 2013/115391 A1) (CAS 1449021-97-9), 3-(4-Chlor-2,6-dimethylphenyl)-8-methoxy-1-methyl-1,8-diazaspiro[4.5]decane-2,4-dion (known from WO 2014/187846 A1) (CAS 1638765-58-8), 3-(4-Chlor-2,6-dimethylphenyl)-8-methoxy-1-methyl-2-oxo-1,8-diazaspiro[4.5]dec-3-en-4-yl-carbonsaureethylester (known from WO 2010/066780 A1, WO 2011151146 A1) (CAS 1229023-00-0), 4-[(5S)-5-(3,5-Dichlor-4-fluorophenyl)-4,5-dihydro-5-(trifluoromethyl)-3-isoxazolyl]-N-[(4R)-2-ethyl-3-oxo-4-isoxazolidinyl]-2-methyl-benzamid (known from WO 2011/067272, WO2013/050302) (CAS 1309959-62-3).

Examples of herbicides a) according to the invention are:

Acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-5-fluoro-6-(7-fluoro-1H-indol-6-yl)pyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bixlozone, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, 1-{2-chloro-3-[(3-cyclopropyl-5-hydroxy-1-methyl-1H-pyrazol-4-yl)carbonyl]-6-(trifluormethyl)phenyl}piperidin-2-on, 4-{2-chloro-3-[(3,5-dimethyl-1H-pyrazol-1-yl)methyl]-4-(methylsulfonyl)benzoyl}-1,3-dimethyl-1H-pyrazol-5-yl-1,3-dimethyl-1H-pyrazol-4-carboxylat, chlorfenac, chlorfenac-sodium, chlorfenprop, chlorflurenol, chlorflurenol-methyl, chloridazon, chlorimuron, chlorimuron-ethyl, 2-[2-chloro-4-(methylsulfonyl)-3-(morpholin-4-ylmethyl)benzoyl]-3-hydroxycyclohex-2-en-1-on, 4-{2-chloro-4-(methylsulfonyl)-3-[(2,2,2-trifluorethoxy)methyl]benzoyl}-1-ethyl-1H-pyrazol-5-yl-1,3-dimethyl-1H-pyrazol-4-carboxylat, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, -2-ethylhexyl, -isobutyl, -isooctyl, -isopropylammonium, -potassium, -triisopropanolammonium, and -trolamine, 2,4-DB, 2,4-DB-butyl, -dimethylammonium, -isooctyl, -potassium, and -sodium, daimuron (dymron), dalapon, dazomet, n-decanol, desmedipham, detosyl-pyrazolate (DTP), dicamba, dichlobenil, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, 3-(2,6-dimethylphenyl)-6-[(2-hydroxy-6-oxocyclohex-1-en-1-yl)carbonyl]-1-methylchinazolin-2,4(1H,3H)-dion, 1,3-dimethyl-4-[2-(methylsulfonyl)-4-(trifluormethyl)benzoyl]-1H-pyrazol-5-yl-1,3-dimethyl-1H-pyrazol-4-carboxylat, dimetrasulfuron, dinitramine, dinoterb, diphenamid, diquat, diquat-dibromid, dithiopyr, diuron, DMPA, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, ethyl-[(3-{2-chloro-4-fluoro-5-[3-methyl-2,6-dioxo-4-(trifluormethyl)-3,6-dihydropyrimidin-1(2H)-yl]phenoxy}pyridin-2-yl)oxy]acetat, F-9960, F-5231, i.e. N-{2-chloro-4-fluoro-5-[4-(3-fluoropropyl)-5-oxo-4,5-dihydro-1H-tetrazol-1-yl]phenyl}ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, fluro-chloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium, and -trimesium, H-9201, i.e. O-(2,4-dimethyl-6-nitrophenyl)O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, (5-hydroxy-1-methyl-1H-pyrazol-4-yl)(3,3,4-trimethyl-1,1-dioxido-2,3-dihydro-1-benzothiophen-5-yl)methanon, 6-[(2-hydroxy-6-oxocyclohex-1-en-1-yl)carbonyl]-1,5-dimethyl-3-(2-methylphenyl)chinazolin-2,4(1H,3H)-dion, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, keto-spiradox, lactofen, lenacil, linuron, MCPA, MCPA-butotyl, -dimethylammonium, -2-ethylhexyl, -isopropylammonium, -potassium, and -sodium, MCPB, MCPB-methyl, -ethyl, and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, 2-({2-[(2-methoxyethoxy)methyl]-6-(trifluormethyl)pyridin-3-yl}carbonyl)cyclohexan-1,3-dion, methyl isothiocyanate, 1-methyl-4-[(3,3,4-trimethyl-1,1-dioxido-2,3-dihydro-1-benzothiophen-5-yl)carbonyl]-1H-pyrazol-5-ylpropan-1-sulfonat, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-(3-chloro-4-isopropylphenyl)-2-methylpentan amide, NGGC-011, napropamide, NC-310, i.e. [5-(benzyloxy)-1-methyl-1H-pyrazol-4-yl](2,4-dichlorophenyl)-methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxy-carbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimi-sulfan, pyrithiobac, pyrithiobac-sodium, pyroxasulfone, pyroxsulam, quinclorac, quinmerac, quino-clamine, quizalofop, quizalofop-ethyl, quizalofop-P, quizalofop-P-ethyl, quizalofop-P-tefuryl, QYM-201, QYR-301, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, tetflupyrolimet, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, ZJ-0862, i.e. 3,4-dichloro-N-{2-[(4,6-dimethoxypyrimidin-2-yl)oxy]benzyl}aniline.

The at least one active ingredient is preferably selected from the group comprising fungicides selected from the group comprising classes as described here above (1) Inhibitors of the respiratory chain at complex, in particular azoles, (2) Inhibitors of the respiratory chain at complex I or II, (3) Inhibitors of the respiratory chain at complex, (4) Inhibitors of the mitosis and cell division, (6) Compounds capable to induce a host defence, (10) Inhibitors of the lipid and membrane synthesis, and (15).

Further preferred, the at least one active ingredient a) as fungicide is selected from the group comprising fluopicolide, fluopyram, fluoxapiprolin, inpyrfluxam, isoflucypram, isothianil, tebuconazole, trifloxystrobin.

The at least one insecticide is preferably selected from the group comprising insecticides selected from the group comprising classes as described here above (2 GABA-gated chloride channel antagonists, (3) Sodium channel modulators/voltage-dependent sodium channel blockers (4) (4) Nicotinic acetylcholine receptor (nAChR) competitive activators, (23) Inhibitors of acetyl-CoA carboxylase, (28) Ryanodinreceptor-modulators, (30) other active ingredients.

Also further preferred, the at least one active ingredient a) as insecticide is selected from the group comprising ethiprole, imidacloprid, spirotetramat, tetraniliprole.

Lastly further preferred, the at least one active ingredient a) as herbicide is selected from the group comprising tembotrione, triafamone and isoxadifen-ethyl.

Even more preferred, the at least one active ingredient is selected from the group comprising fluopicolide, fluopyram, fluoxapiprolin, inpyrfluxam, isoflucypram, isothianil, tebuconazole, trifloxystrobin, ethiprole, imidacloprid, spirotetramat, tetraniliprole, tembotrione, triafamone and isoxadifen-ethyl.

All named active ingredients as described here above can be present in the form of the free compound or, if their functional groups enable this, an agrochemically active salt thereof.

Furthermore, mesomeric forms as well as stereoisomers or enantiomers, where applicable, shall be enclosed, as these modifications are well known to the skilled artisan, as well as polymorphic modifications.

If not otherwise specified, in the present invention solid, agrochemical active compounds a) are to be understood as meaning all substances customary for plant treatment, whose melting point is above 20° C.

Spreading Agents (b):

Suitable spreading agents are selected from the group comprising mono- and diesters of sulfosuccinate metal salts with branched or linear alcohols comprising 1-10 carbon atoms, in particular alkali metal salts, more particular sodium salts, and most particular sodium dioctylsulfosuccinate; as well as organosilicone ethoxylates such as organomodified polysiloxanes/trisiloxane alkoxylates with the following CAS No. 27306-78-1, 67674-67-3, 134180-76-0, e.g., Silwet® L77, Silwet® 408, Silwet® 806, BreakThru® S240, BreakThru® S278.

Other suitable spreading agents are ethoxylated diacetylene-diols with 1 to 6 EO, e.g. Surfynol® 420 and 440.

Other suitable spreading agents are alcohol ethoxylates, e.g. Break-Thru® Vibrant,

Preferred are polyalkyleneoxide modified heptamethyltrisiloxane, more preferred selected from the group comprising the siloxane groups Poly(oxy-1,2-ethanediyl), .alpha.-methyl-.omega.-[3-[1,3,3,3-tetramethyl-1-[(trimethylsilyl)oxy]disiloxanyl]propoxy] (CAS No (27306-78-1), Poly(oxy-1,2-ethanediyl), .alpha.-[3-[1,3,3,3-tetramethyl-1-[(trimethylsilyl)oxy]disiloxanyl]propyl]-.omega.-hydroxy (Cas No 67674-67-3), and Oxirane, methyl-, polymer with oxirane, mono3-1,3,3,3-tetramethyl-1-(trimethylsilyl)oxydisiloxanylpropyl ether (Cas No 134180-76-0).

Preferably the spreading agent is selected from the group comprising sodium dioctylsulfosuccinate, polyalkyleneoxide modified heptamethyltrisiloxane and ethoxylated diacetylene-diols.

Uptake Enhancers (c)

Oils that function as penetration promoters, suitable oils are all substances of this type which can customarily be employed in agrochemical agents. Preferably, oils of vegetable, mineral and animal origin and alkyl esters of these oils. Examples are:
sunflower oil, rapeseed oil, corn oil, soybean oil, rice bran oil, olive oil;
ethylhexyl oleate, ethylhexyl palmitate, ethylhexyl myristate/laurate, ethylhexyl laurate, ethylhexyl caprylate/caprate, iso-propyl myristate, iso-propyl palmitate, methyl oleate, methyl palmitate, ethyl oleate, rape seed oil methyl ester, soybean oil methyl ester, rice bran oil methyl ester,
Mineral oils, e.g. Exxsol® D100, Solvesso® 200ND, and white oil.
tris-alkyl-phosphate esters, preferably tris (2-ethylhexyl) phosphate, e.g. Disflamoll® TOF;

The uptake enhancer may also be selected from the following group of compounds:
i. ethoxylated branched alcohols (e.g. Genapol® X-type) with 2-20 EO units;
ii. methyl end-capped, ethoxylated branched alcohols (e.g. Genapol® XM-type) comprising 2-20 EO units;
iii. ethoxylated coconut alcohols (e.g. Genapol® C-types) comprising 2-20 EO units;
iv. ethoxylated C12/15 alcohols (e.g. Synperonic© A-types) comprising 2-20 EO units;
v. propoxy-ethoxylated alcohols, branched or linear, e.g. Antarox© B/848, Atlas® G5000, Lucramul® HOT 5902;
vi. propoxy-ethoxylated fatty acids, Me end-capped, e.g. Leofat® 0C0503M;
vii. alkyl ether citrate surfactants (e.g. Adsee® CE range, Akzo Nobel);
viii. ethoxylated mono- or diesters of glycerine comprising fatty acids with 8-18 carbon atoms and an average of 10-40 EO units (e.g. Crovol® range);
ix. castor oil ethoxylates comprising an average of 5-40 EO units (e.g. Berol® range, Emulsogen® EL range).
x. ethoxylated oleic acid (e.g. Alkamuls® A and AP) comprising 2-20 EO units;
xi. ethoxylated sorbitan fatty acid esters comprising fatty acids with 8-18 carbon atoms and an average of 10-50 EO units (e.g. Arlatone® T, Tween range).

Preferred uptake enhancers according to the present invention are tris (2-ethylhexyl) phosphate, rapeseed oil methyl esters, ethoxylated coconut alcohols, propoxy-ethoxylated alcohols and mineral oils.

Other Formulants (d)

d1 Suitable non-ionic surfactants or dispersing aids d1) are all substances of this type which can customarily be employed in agrochemical agents. Preferably, polyethylene oxide-polypropylene oxide block copolymers, preferably having a molecular weight of more than 6,000 g/mol or a polyethylene oxide content of more than 45%, more preferably having a molecular weight of more than 6,000 g/mol and a polyethylene oxide content of more than 45%, furthermore polyvinyl alcohol, polyoxyalkylenamine derivatives, polyvinylpyrrolidone, copolymers of polyvinyl alcohol and polyvinylpyrrolidone, and copolymers of (meth)acrylic acid and (meth)acrylic acid esters, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphated, sulphonated or sulphated and neutralized with bases.

Possible anionic surfactants el) are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid.

d2 A rheological modifier is an additive that when added to the recipe at a concentration that reduces the gravitational separation of the dispersed active ingredient during storage results in a substantial increase in the viscosity at low shear rates. Low shear rates are defined as 0.1 s⁻¹ and below and a substantial increase as greater than ×2 for the purpose of this invention. The viscosity can be measured by a rotational shear rheometer.

Suitable rheological modifiers E2) by way of example are:
Polysaccharides including xanthan gum, guar gum and hydroxyethyl cellulose. Examples are Kelzan®, Rhodopol® G and 23, Satiaxane® CX911 and Natrosol® 250 range.
Clays including montmorillonite, bentonite, sepeolite, attapulgite, laponite, hectorite. Examples are Veegum® R, Van Gel® B, Bentone® CT, HC, EW, Pangel® M100, M200, M300, S, M, W, Attagel® 50, Laponite® RD,
Fumed and precipitated silica, examples are Aerosil® 200, Sipernat® 22.

Preferred are xanthan gum, montmorillonite clays, bentonite clays and fumed silica.

d3 Suitable antifoam substances d3) are all substances which can customarily be employed in agrochemical agents for this purpose. Silicone oils, silicone oil preparations are preferred. Examples are Silcolapse® 426 and 432 from Bluestar Silicones, Silfoam® SRE and SC132 from Wacker, SAF-184® fron Silchem, Foam-Clear ArraPro-S® from Basildon Chemical Company Ltd, SAG© 1572 and SAG© 30 from Momentive [Dimethyl siloxanes and silicones, CAS No. 63148-62-9]. Preferred is SAG© 1572.

d4 Suitable antifreeze agents are all substances which can customarily be employed in agrochemical agents for this purpose. Suitable examples are propylene glycol, ethylene glycol, urea and glycerine.

d5 Suitable other formulants d5) are selected from biocides, colourants, pH adjusters, buffers, stabilisers, antioxidants, inert filling materials, humectants, crystal growth inhibitors, micronutirients by way of example are:

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1,2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Possible colourants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Possible pH adjusters and buffers are all substances which can customarily be employed in agrochemical agents for this purpose. Citric acid, sulfuric acid, hydrochloric acid, sodium hydroxide, sodium hydrogen phosphate (Na₂HPO₄), sodium dihydrogen phosphate (NaH₂PO₄), potassium dihydrogen phosphate (KH₂PO₄), potassium hydrogen phosphate (K₂HPO₄), may be mentioned by way of example.

Suitable stabilisers and antioxidants are all substances which can customarily be employed in agrochemical agents for this purpose. Butylhydroxytoluene [3,5-Di-tert-butyl-4-hydroxytoluol, CAS-No. 128-37-0] is preferred.

Carriers (e) are those which can customarily be used for this purpose in agrochemical formulations.

A carrier is a solid or liquid, natural or synthetic, organic or inorganic substance that is generally inert, and which may be used as a solvent. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks.

Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of
alcohols and polyols (which may optionally also be substituted, etherified and/or esterified, such as ethanol, propanol, butanol, benzylalcohol, cyclohexanol or glycol, 2-ethyl hexanol),
ethers such as dioctyl ether, tetrahydrofuran, dimethyl isosorbide, solketal, cyclopentyl methyl ether, solvents offered by Dow under the Dowanol Product Range e.g. Dowanol DPM, anisole, phenetole, different molecular weight grades of dimethyl polyethylene glycol, different molecular weight grades of dimethyl polypropylene glycol, dibenzyl ether
ketones (such as acetone, methyl ethyl ketone, methyl isobutyl ketone, cyclopentanone, cyclohexanone, cycloheptanone, acetophenone, propiophenone),
lactate esters, such as methyl lactate, ethyl lactate, propyl lactate, butyl lactate, 2-ethyl hexyl lactate
(poly)ethers such as different molecular weight grades of polyethylene glycol, different molecular weight grades of polypropylene glycol
unsubstituted and substituted amines
amides (such as dimethylformamide, or N,N-dimethyl lactamide, or N-formyl morpholine, or fatty acid amides such N,N-dimethyl decanamide or N,N-dimethyl dec-9-en-amide) and esters thereof
lactams (such as 2-pyrrolidone, or N-alkylpyrrolidones, such as N-methylpyrrolidone, or N-butylpyrrolidone, or N-octylpyrrolidone, or N-dodecylpyrrolidone or N-methyl caprolactam, N-alkyl caprolactam)
lactones (such as gamma-butyrolactone, gamma-valerolactone, delta-valerolactone, or alpha-methyl gamma-butyrolactone
sulfones and sulfoxides (such as dimethyl sulfoxide),
nitriles, such as linear or cyclic alkyl nitriles, in particular acetonitrile, cyclohexane carbonitrile, octanonitrile, dodecanonitrile).
linear and cyclic carbonates, such as diethyl carbonate, dipropyl carbonate, dibutyl carbonate, dioctyl carbonate, or ethylene carbonate, propylene carbonate, butylene carbonate, glycerine carbonate

Most preferred the carrier is water.

These spray liquids are applied by customary methods, i.e., for example, by spraying, pouring or injecting, in particular by spraying, and most particular by spraying by UAV.

The application rate of the formulations according to the invention can be varied within a relatively wide range. It is guided by the particular active agrochemicals and by their amount in the formulations.

With the aid of the formulations according to the invention it is possible to deliver active agrochemical to plants and/or their habitat in a particularly advantageous way.

The present invention is also directed to the use of agrochemical compositions according to the invention for the application of the agrochemical active compounds contained to plants and/or their habitat.

With the formulations of the invention it is possible to treat all plants and plant parts. By plants here are meant all plants and plant populations, such as desirable and unwanted wild plants or crop plants (including naturally occurring crop plants). Crop plants may be plants which can be obtained by conventional breeding and optimization methods or by biotechnological and gene-technological methods or combinations of these methods, including the transgenic plants and including the plant cultivars which can or cannot be protected by varietal property rights. By plant parts are to be meant all above-ground and below-ground parts and organs of the plants, such as shoot, leaf, flower and root, an exemplary listing embracing leaves, needles, stems, trunks, flowers, fruit bodies, fruits and seeds and also roots, tubers and rhizomes. The plant parts also include harvested material and also vegetative and generative propagation material.

What may be emphasized in this context is the particularly advantageous effect of the formulations according to the invention with regard to their use in cereal plants such as, for example, wheat, oats, barley, spelt, triticale and rye, but also in maize, sorghum and millet, rice, sugar cane, soya beans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, kumquats, tangerines and satsumas, nuts such as, for example, pistachios, almonds, walnuts and pecan nuts, tropical fruits such as, for example, mango, papaya, pineapple, dates and bananas, and grapes) and vegetables (comprising leaf vegetables such as, for example, endives, corn salad, Florence fennel, lettuce, cos lettuce, Swiss chard, spinach and chicory for salad use, cabbages such as, for example, cauliflower, broccoli, Chinese leaves, Brassica oleracea (L.) convar. acephala var. sabellica L. (curly kale, feathered cabbage), kohlrabi, Brussels sprouts, red cabbage, white cabbage and Savoy cabbage, fruit vegetables such as, for example, aubergines, cucumbers, capsicums, table pumpkins, tomatoes, courgettes and sweetcorn, root vegetables such as, for example celeriac, wild turnips, carrots, including yellow cultivars, Raphanus sativus var. niger and var. radicula, beetroot, scorzonera and celery, legumes such as, for example, peas and beans, and vegetables from the Allium family such as, for example, leeks and onions.

The treatment of the plants and plant parts in accordance with the invention with the inventive formulations is carried out directly or by action on their environment, habitat or storage area in accordance with the customary treatment methods, for example by dipping, spraying, vaporizing, atomizing, broadcasting or painting on and, in the case of propagation material, especially seeds, additionally by single or multiple coating.

The active agrochemicals comprised develop a better biological activity than when applied in the form of the corresponding conventional formulations.

Leaf Surfaces

In Tables 1a and 1b the contact angle of water on leaf surfaces for textured and non-textured is shown.

TABLE 1a
Plants with textured leaves

| | | Contact angle |
|---|---|---|
| | | of water ° |
| Plant | Species | (adaxial) |
| barley | Hordeum vulgare (var. | 143° |
| | Montoya) | |
| corn, BBCH-11 | Zea mays | 150° |
| corn, BBCH-12 | Zea mays | 149° |
| corn, BBCH-13/14 | Zea mays | 148° |
| soybean, BBCH-12 | Glycine max | 149° |
| soybean, BBCH-13 | Glycine max | 144° |
| rice | Oryza sativa | 180° |
| wheat, BBCH-12 | Triticum aestivum | 148° |
| fat-hen | Chenopodium album | 137° |
| purple crabgrass | Digitaria sanguinalis | 144° |

TABLE 1b
Plants with non-textured leaves

| | | Contact angle |
|---|---|---|
| | | of water ° |
| Plant | Species | (adaxial) |
| apple | Malus domestica | 104° |
| tomato | Solanum lycopersicum | 106° |
| corn, BBCH-15/16 | Zea mays | 108° |
| corn, BBCH-17 | Zea mays | 107° |
| corn, BBCH-18 | Zea mays | 96° |
| corn, BBCH-19 | Zea mays | 87° |
| velvetleaf | Abutilon theophrasti | 103° |
| redroot pigweed | Amaranthus retroflexus | not measured |

Examples of non-textured crops and plants include tomatoes, peppers, potatoes, carrot, celery, sugar beet, beetroot, spinach, lettuce, beans, peas, clover, apple, pear, peach, apricot, plum, mango, avocado, olive, citrus, orange, lemon, lime, grape, fig, cucumber, melon, water melon, strawberry, raspberry, blueberry, sunflower, pumpkin, soybean (≥GS 16 (BBCH 16)), corn (≥GS 15 (BBCH 15), cotton.

Examples of textured crops and plants include garlic, onions, leeks, soybean (≤GS 16 (BBCH 16)), oats, wheat, barley, rice, sugarcane, pineapple, banana, linseed, lilies, orchids, corn (≤GS 15 (BBCH 15)), cabbage, brussels sprouts, broccoli, Cauliflower, rye, rapeseed, tulips and peanut.

Examples of non-textured weeds include Abutilon theophrasti, Capsella bursa-pastoris, Datura stramonium, Galium aparine, Ipomoea purpurea, Polygonum lapathifolium, Portulaca oleracea, Senecio vulgaris, Sida spinosa, Sinapis arvensis, Solanum nigrum, Stellaria media, Xanthium orientale, Cyperus rotundus, and Amaranthus retroflexus.

Examples of textured weeds include Cassia obtusifolia, Chenopodium album, Agropyron repens, Alopecurus myosuroides, Apera spica-venti, Avena fatua, Brachiaria plantaginea, Bromus secalinus, Cynodon dactylon, Digitaria sanguinalis, Echinochloa crus-galli, Panicum dichotomiflorum, Poa annua, Setaria faberi and Sorghum halepense.

The invention is illustrated by the following examples.

### EXAMPLES

Method 1: SC Preparation

The method of the preparation of suspension concentrate formulations are known in the art and can be produced by known methods familiar to those skilled in the art. A 2% gel of the xanthan (c) in water and the biocides (c) was prepared with low shear stirring. The active ingredient (a), non-ionic and anionic dispersants (c), antifoam (c) and other formulants (c) were mixed with water to form a slurry, first mixed with a high shear rotor-stator mixer (Ultra-Turrax®) to reduce the particle size D(v,0.9) to approximately 50 microns, then passed through one or more bead mills (Eiger® 250 Mini Motormill) to achieve a particles size D(v,0.9) typically 1 to 15 microns. Then the additives (b), (c) and (d) and xanthan gel prepared above were added and mixed in with low shear stirring until homogeneous. Finally, the pH is adjusted if needed with acid or base (e).

Method 2: WG Preparation

The methods of the preparation water dispersible granule formulations are known in the art and can be produced by known methods familiar to those skilled in the art.

For example, to produce a fluid bed granule first a water-based technical concentrate has to be prepared. With low shear stirring all ingredients (a, b and c) like e.g. the active ingredient, surfactants, dispersants, binder, antifoam, spreader, and filler are mixed in water and finally pre-milled in a high shear rotor-stator mixer (Ultra-Turrax®) to reduce the particle size D(v,0.9) to approximately 50 microns, afterwards passed through one or more bead mills (KDL, Bachofen, Dynomill, Bühler, Drais, Lehmann) to achieve a particles size D(v,0.9) typically 1 to 15 microns. This water-based technical concentrate is then spray-dried in a fluid-bed granulation process to form the wettable granules (WG).

The particle size is determined according to CIPAC (CIPAC=Collaborative International Pesticides Analytical Council; www.cipac.org) method MT 187. The particle size distribution is determined by means of laser diffraction. A representative amount of sample is dispersed in degassed water at ambient temperature (self-saturation of the sample), treated with ultrasound (usually 60 s) and then measured in a device from the Malvern Mastersizer series (Malvern Panalytical). The scattered light is measured at various angles using a multi-element detector and the associated numerical values are recorded. With the help of the Fraunhofer model, the proportion of certain size classes is calculated from the scatter data and from this a volume-weighted particle size distribution is calculated. Usually the d50 or d90 value=active ingredient particle size (50 or 90% of all volume particles) is given. The average particle size denotes the d50 value.

Likewise, any other spraying process, like e.g. classical spray drying can be used as granulation method.

A further technique to produce water dispersible granules is for example low pressure extrusion. The ingredients of the formulation are mixed in dry from and are subsequently milled, e.g. using air-jet milling to reduce the particle size. Subsequently this dry powder is stirred while water is added to the mixture (approximately 10-30 wt %, dependent on the composition of the formulation). In a further step the mixture is pushed through an extruder (like a dome extruder, double dome extruder, basket extruder, sieve mill, or similar device) with a die size of usually between 0.8 and 1.2 mm to form the extrudates. In a last step the extrudates are post-dried, e.g. in a fluidized bed dryer to reduce the water content of the powder, commonly to a level of 1-3 wt % of residual water.

Method 3: EC Preparation

The method of the preparation of EC formulations are known in the art and can be produced by known methods familiar to those skilled in the art. In general, EC formulations are obtained by mixing the active ingredient (a) with the rest of the formulation components, which include, amongst others, surfactants (c), spreader (b), a carrier (d) in a vessel equipped with a stirring device. In some cases the dissolving or mixing was facilitated by raising the temperature slightly (not exceeding 60° C.). Stirring is continued until a homogeneous mixture has been obtained.

Method 4: OD Preparation

Formulation components (c), carrier (d) active ingredient (a), spreader (b) are weighed in, homogenized with a high-shear device (e.g. Ultraturrax or colloidal mill) and subsequently milled in a bead mill (e.g. Dispermat SL50, 80% filling, 1.0-1.25 mm glass beads, 4000 rpm, circulation grinding) until a particle size of <10μ is achieved. Alternatively, formulation components are mixed in a bottle followed by addition of approx. 25 vol.-% of 1.0-1.25 mm glass beads. The bottle is then closed, clamped in an agitator apparatus (e.g. Retsch MM301) and treated at 30 Hz for several minutes until a particle size of <10μ is achieved.

Method 5: Coverage

Greenhouse plants in the development stage as indicated in Tables 1a&1b were used for these experiments. Single leaves were cut just before the spraying experiment, placed into petri dishes and attached by tape at both tips at 0° (horizontally) or at 600 (so that 50% of leaf area can be sprayed). The leaves were carried with caution to avoid damage of the wax surface. These horizontally orientated leaves were either a) placed into a spay chamber where the spray liquid was applied via a hydraulic nozzle or b) a 4 μl drop of spray liquid was pipetted on top without touching the leaf surface.

A small amount of UV dye was added to the spray liquid to visualize the spray deposits under UV light. The concentration of the dye has been chosen such that it does not influence the surface properties of the spray liquid and does not contribute to spreading itself. Tinopal OB as a colloidal suspension was used for all flowable and solid formulation such as WG, SC, OD and SE. Tinopal CBS-X or Blankophor SOL were used for formulations where active ingredient is dissolved such as EC, EW and SL. The Tinopal CBS-X was dissolved in the aqueous phase and the Blankophor SOL dissolved in the oil phase.

After evaporation of the spray liquid, the leaves were placed into a Camag, Reprostar 3 UV chamber where pictures of spray deposits were taken under visual light and under UV light at 366 nm. A Canon EOS 700D digital camera was attached to the UV chamber and used to acquire images the leaves. Pictures taken under visual light were used to subtract the leaf shape from the background. ImageJ software was used to calculate either a) the percentage coverage of the applied spray for sprayed leaves or b) spread area for pipetted drops in mm².

Method 6: Insecticide Greenhouse Tests

Selected crops were grown under greenhouse conditions in plastic pots containing “peat soil T”. At appropriate crop stage, plants were prepared for the treatments, e.g. by infestation with target pest approximately 2 days prior to treatment (s. table below).

Spray solutions were prepared with different doses of active ingredient directly by dilution of formulations with tap water and addition of appropriate amount of additives in tank mix, where required.

The application was conducted with a tracksprayer onto the upperside of leaves with 300 l/ha or 10 l/ha application volume. Nozzles used: Lechler's TeeJet TP8003E (for 300 l/ha) and Lechler's 652.246 together with a pulse-width-module (PWM) (for 10 l/ha). For each single dose applied, usually 2 to 5 replicates were simultaneously treated.

After treatment, plants were artificially infested, if needed, and kept during test duration in a greenhouse or climate chamber. The efficacy of the treatments was rated after evaluation of mortality (in general, given in %) and/or plant protection (calculated e.g. from feeding damage in comparison to corresponding controls) at different points of time. Only mean values are reported.

TABLE M1
Pests and crops used in the tests.

| crop | crop stage | infestation | pest | English name | pest life stage | test objective |
|---|---|---|---|---|---|---|
| soybean | BBCH12, | after | Nezara | green stink bug | 10× nymphs | contact and |
| | 5 plants | treatment | viridula | | N2-N3 | oral uptake |
| | in pot | | | | | |
| cabbage | BBCH12, | prior to | Myzus | green peach | mixed | translaminar |
| | 1-leaf | treatment | persicae | aphid | population | activity |

Selected crops were grown under greenhouse conditions in plastic pots containing “peat soil T”. At appropriate crop stage, plants were prepared for the treatments, e.g. by infestation with target pest approximately 2 days prior to treatment (table M1).

Spray solutions were prepared with different doses of active ingredient directly by dilution of formulations with tap water and addition of appropriate amount of additives in tank mix, where required.

The application was conducted with tracksprayer onto upperside of leaves with 300 l/ha or 10 l/ha application volume. Nozzles used: Lechler's TeeJet TP8003E (for 300 l/ha) and Lechler's 652.246 together with a pulse-width-module (PWM) (for 10 l/ha). For each single dose applied, usually 2 to 5 replicates were simultaneously treated.

After treatment, plants were artificially infested, if needed, and kept during test duration in a greenhouse or climate chamber. The efficacy of the treatments was rated after evaluation of mortality (in general, given in %) and/or plant protection (calculated e.g. from feeding damage in comparison to corresponding controls) at different points of time. Only mean values are reported.

Method 7: Cuticle Wash-Off

A disc from an apple cuticle was fixed with the outside surface facing upwards to a glass microscope slide with a thin layer of medium viscosity silicone oil. To this 0.9 μl drops of the different formulations diluted at the spray dilution in deionised water containing 5% CIPAC C water were applied with a micropipette and left to dry for 1 hour. Each deposit was examined in an optical transmission microscope fitted with crossed polarising filters and an image recorded. The slide containing the cuticle with the dried droplets of the formulations was held under gently running deionised water (flow rate approximately 300 ml/minute at a height 10 cm below the tap outlet) for 15 s. The glass slide was allowed to dry and the deposits were re-examined in the microscope and compared to the original images. The amount of active ingredient washed off was visually estimated and recorded in steps of 10%. Three replicates were measured and the mean value recorded.

Method 8: Leaf Wash-Off

Apple or corn leaf sections were attached to a glass microscope slide. To this 0.9 μl drops of the different formulations diluted at the spray dilution in deionised water containing 5% CIPAC C water and a small amount of fluorescent tracer (Tinopal OB as a micron sized aqueous suspension) were applied with a micropipette and left to dry for 1 hour. Under UV illumination (365 nm) the leaf deposits were imaged by a digital camera. The leaf sections were then held under gently running deionised water (flow rate approximately 300 ml/minute at a height 10 cm below the tap outlet) for 15 s. The leaf sections were allowed to dry and the deposits were re-imaged and compared to the original images. The amount of active ingredient washed off was visually estimated between 5 with most remaining and 1 with most removed. Three or more replicates were measured and the mean value recorded.

Method 9: Suspo-Emulsion Preparation

The method of the preparation of suspo-emulsion formulations are known in the art and can be produced by known methods familiar to those skilled in the art. A 2% gel of the xanthan in water and the biocides (e) was prepared with low shear stirring. The active ingredient spiroxamine (a), oils (b/c) and antioxidant (e) were mixed and added to an aqueous dispersion comprising a portion of the non-ionic dispersants (c) under high shear mixing with a rotor-stator mixer until an oil in water emulsion was formed with a droplet size D(v,0.9) typically 1 to 5 microns. The active ingredient (a), the remaining non-ionic and anionic dispersants (c/e) and other remaining formulants (c/e) were mixed with the remaining water to form a slurry, first mixed with a high shear rotor-stator mixer to reduce the particle size D(v,0.9) to approximately 50 microns, then passed through one or more bead mills to achieve a particles size D(v,0.9) typically 1 to 15 microns as required for the biological performance of the active ingredient(s). Those skilled in the art will appreciate that this can vary for different active ingredients. The oil in water emulsion, polymer dispersion (c/d) and xanthan gel were added and mixed in with low shear stirring until homogeneous.

Method 10: Description for Herbicide Greenhouse Tests

Seeds of crops and monocotyledonous and dicotyledonous harmful plants are laid out in sandy loam in plastic pots, covered with soil and cultivated in a greenhouse under optimum growth conditions. Two to three weeks after sowing, the test plants are treated at the one- to two-leaf stage. The test herbicide formulations are prepared with different concentrations and sprayed onto the surface of the green parts of the plants using different water application rates: 200 I/ha as a standard conventional rate and 10 l/ha as an ultra-low-volume (ULV) application rate. The nozzle type used for all applications is TeeJet DG 95015 EVS. The ULV application rate is achieved by using a pulse-width-modulation (PWM)-system that gets attached to the nozzle and the track sprayer device. After application, the test plants were left to stand in the greenhouse for 3 to 4 weeks under optimum growth conditions. Then, the activity of the herbicide formulation is scored visually (for example: 100% activity=the whole plant material is dead, 0% activity=plants are similar to the non-treated control plants).

TABLE M2
Plant species used in the tests.

| | Abbreviation/EPPO | Crop |
|---|---|---|
| Plant species | Code | Variety |
| Setaria viridis | SETVI | |
| Echinochloa crus-galli | ECHCG | |
| Alopecurus myosuroides | ALOMY | |
| Hordeum murinum | HORMU | |
| Avena fatua | AVEFA | |
| Lolium rigidum | LOLRI | |
| Matricaria inodora | MATIN | |
| Veronica persica | VERPE | |
| Abutilon theophrasti | ABUTH | |
| Pharbitis purpurea | PHBPU | |
| Polygonum convolvulus | POLCO | |
| Amaranthus retroflexus | AMARE | |
| Stellaria media | STEME | |
| Zea mays | ZEAMA | Aventura |
| Triticum aestivum | TRZAS | Triso |
| Brassica napus | BRSNW | Fontan |

Method 11: Description for Fungicide Greenhouse Tests

Seeds were laid out in “peat soil T” in plastic pots, covered with soil and cultivated in a greenhouse under optimum growth conditions. Two to three weeks after sowing, the test plants were treated at the one- to two-leaf stage. The test fungicide formulations were prepared with different concentrations and sprayed onto the surface of the plants using different water application rates: 200 I/ha as a standard conventional rate and 10 l/ha as an ultra-low-volume (ULV) application rate. The nozzle type used for all applications was TeeJet TP 8003E, used with 0.7-1.5 bar and 500-600 mm height above plant level. Cereal were put in an 450 angle as this reflected best the spray conditions in the field for cereals. The ULV application rate was achieved by using a pulse-width-modulation (PWM) system attached to the nozzle and the track sprayer device at 30 Hz, opening 8-100% (10 l/ha-200 l/ha spray volume).

In a protective treatment the test plants were inoculated 1 day after the spray application with the respective disease and left to stand in the greenhouse for 1 to 2 weeks under optimum growth conditions. Then, the activity of the fungicide formulation was assessed visually.

In curative conditions plants were first inoculated with the disease and treated 2 days later with the fungicide formulations. Visual assessment of the disease was done 5 days after application of formulations.

The practices for inoculation are well known to those skilled in the art.

TABLE M3
Diseases and crops used in the tests.

| | | | | Abbreviation/ |
|---|---|---|---|---|
| Plant | Crop | | | EPPO Code |
| species | Variety | Disease | English Name | disease |
| Soybean | Merlin | Phakopsora | Soybean rust | PHAKPA |
| | | pachyrhizi | | |
| Wheat | Monopol | Puccinia triticina | Brown rust | PUCCRT |
| Barley | Gaulois | Pyrenophora teres | Net blotch | PYRNTE |
| Barley | Villa | Blumeria graminis | Powdery mildew | ERYSGH |
| Tomato | Rentita | Phytophtora | Late blight | PHYTIN |
| | | infestans | | |

Method 12: Cuticle Penetration Test

The cuticle penetration test is a further developed and adapted version of the test method SOFU (simulation of foliar uptake) originally described by Schönherr and Baur (Schönherr, J., Baur, P. (1996), Effects of temperature, surfactants and other adjuvants on rates of uptake of organic compounds. In: The plant cuticle—an integrated functional approach, 134-155. Kerstiens, G. (ed.), BIOS Scientific publisher, Oxford); it is well suited for systematic and mechanistic studies on the effects of formulations, adjuvants and solvents on the penetration of agrochemicals.

Apple leaf cuticles were isolated from leaves taken from trees growing in an orchard as described by Schönherr and Riederer (Schönherr, J., Riederer, M. (1986), Plant cuticles sorb lipophilic compounds during enzymatic isolation. Plant Cell Environ. 9, 459-466). Only the astomatous cuticular membranes of the upper leaf surface lacking stomatal pores were obtained. Discs having diameters of 18 mm were punched out of the leaves and infiltrated with an enzymatic solution of pectinase and cellulase. The cuticular membranes were separated from the digested leaf cell broth, cleaned by gently washing with water and dried. After storage for about four weeks the permeability of the cuticles reaches a constant level and the cuticular membranes are ready for the use in the penetration test.

The cuticular membranes were applied to diffusion vessels. The correct orientation is important: the inner surface of the cuticle should face to the inner side of the diffusion vessel. A spray was applied in a spray chamber to the outer surface of the cuticle. The diffusion vessel was turned around and carefully filled with acceptor solution. Aqueous mixture buffered to pH 5.5 was used as acceptor medium to simulate the apoplast as natural desorption medium at the inner surface of the cuticle.

The diffusion vessels filled with acceptor and stirrer were transferred to a temperature-controlled stainless steel block which ensures not only a well-defined temperature but also a constant humidity at the cuticle surface with the spray deposit. The temperature at the beginning of experiments was 25° C. or 30° C. and changes to 350 24 h after application at constantly 60% relative humidity.

An autosampler took aliquots of the acceptor in regular intervals and the content of active ingredient is determined by HPLC (DAD or MS). All data points were finally processed to obtain a penetration kinetic. As the variation in the penetration barrier of the cuticles is high, five to ten repetitions of each penetration kinetic were made.

Materials

TABLE MAT1
Exemplified trade names and CAS-No's of preferred super-spreading
compounds (b)

| Product | Chemical name | Cas No. | Supplier |
|---|---|---|---|
| Geropon ® | Dioctylsulfosuccinate sodium | 577-11-7 | Rhodia |
| DOS-PG | salt (65-70% in propylene | | |
| | glycol) | | |
| Synergen ® | Dioctylsulfosuccinate sodium | 577-11-7 | Clariant |
| W 10 | salt (65-70% in propylene | | |
| | glycol) | | |
| Aerosol ® | Dioctylsulfosuccinate sodium | 577-11-7 | Cytec |
| OT 70 PG | salt (65-70% in propylene | | |
| | glycol) | | |
| Lankropol | Dioctylsulfosuccinate sodium | 577-11-7 | Nouryon |
| KPH70 | salt (65-70% in propylene | | |
| | glycol) | | |
| Enviomet | Dioctylsulfosuccinate sodium | 577-11-7 | Innospec |
| EM 5669 | salt (65-70% in propylene | | |
| | glycol) | | |
| Surfynol ® | 2,4,7,9-Tetramethyl-5-Decyne- | 9014-85-1 | Evonik |
| S420 | 4,7-Diol ethoxylate (1 mole) | | |
| Surfynol ® | 2,4,7,9-Tetramethyl-5-Decyne- | 9014-85-1 | Evonik |
| S440 | 4,7-Diol ethoxylate (3.5 moles) | | |
| Surfynol ® | 2,4,7,9-Tetramethyl-5-Decyne- | 9014-85-1 | Evonik |
| S465 | 4,7-Diol ethoxylate (10 moles) | | |
| Surfynol ® | 2,4,7,9-Tetramethyl-5-Decyne- | 9014-85-1 | Evonik |
| S485 | 4,7-Diol ethoxylate (30 moles) | | |
| Break-Thru ® | Not disclosed | | Evonik |
| Vibrant | | | |
| Genapol ® | C10-12 alcohol alkoxylate | | Clariant |
| EP 0244 | (PO + EO) | | |
| Synergen ® | C11 alcohol alkoxylate | | Clariant |
| W06 | (PO + EO) | | |
| Genapol ® | C12-15 alcohol alkoxylate | | Clariant |
| EP 2584 | (PO + EO) | | |
| Agnique ® | Oligomeric D-glucopyranose | 68515-73-1 | BASF |
| PG8107 | decyl octyl glycosides | | |
| Silwet ® L77 | 3-(2-methoxyethoxy)propyl- | 27306-78-1 | Momentive |
| | methyl- | | |
| | bis(trimethylsilyloxy)silane | | |
| Silwet ® 408 | 2-[3- | 67674-67-3 | Momentive |
| | [[dimethyl(trimethylsilyloxy) | | |
| | silyl]oxy-methyl- | | |
| | trimethylsilyloxysilyl]propoxy] | | |
| | ethanol | | |
| Silwet ® 806 | 3-[methyl- | 134180-76-0 | Momentive |
| | bis(trimethylsilyloxy)silyl] | | |
| | propan-1-ol; 2-methyloxirane; | | |
| | oxirane | | |
| Break-thru ® | 3-[methyl- | 134180-76-0 | Evonik |
| S240 | bis(trimethylsilyloxy)silyl] | | |
| | propan-1-ol; 2-methyloxirane; | | |
| | oxirane | | |
| Break-thru ® | 3-(2-methoxyethoxy)propyl- | 27306-78-1 | Evonik |
| S278 | methyl- | | |
| | bis(trimethylsilyloxy)silane | | |
| Silwet ® HS | | | |
| 312 | | | |
| Silwet ® HS | | | |
| 604 | | | |
| BreakThru ® | Siloxanes and Silicones, cetyl | 191044-49-2 | Evonik |
| OE 444 | Me, di-Me | | |

TABLE MAT2
Exemplified trade names and CAS-No's of preferred uptake enhancing
compounds (b)

| Product | Chemical name | Cas No. | Supplier |
|---|---|---|---|
| Emulsogen ® | Ethoxylated Castor Oil with | 61791-12-6 | Clariant |
| EL 400 | 40 EO | | |
| ETOCAS ® | Ethoxylated Castor Oil with | 61791-12-6 | Croda |
| 10 | 10 EO | | |
| Crovol ® | fats and glyceridic oils, | 70377-91-2 | Croda |
| CR70G | vegetable, ethoxylated | | |
| Synperonic ® | alcohol ethoxylate (C12/C15- | 68131-39-5 | Croda |
| A3 | EO3) | | |
| Synperonic ® | alcohol ethoxylate (C12/C15- | 68131-39-5 | Croda |
| A7 | EO7) | | |
| Genapol ® | alcohol ethoxylate (iso-C13- | 9043-30-5 | Clariant |
| X060 | EO6) | | |
| Alkamuls ® | Oleic acid, ethoxylated | 9004-96-0 | Solvay |
| A | | | |
| Lucramul ® | alcohol ethoxylate- | 64366-70-7 | Levaco |
| HOT 5902 | propoxylate (C8-PO8/EO6) | | |
| Antarox | Butyl alcohol | 9038-95-3 | Solvay |
| B/848 | propoxylate/ethoxylate | | |
| Tween ® 80 | Sorbitan monooleate, | 9005-65-6 | Croda |
| | ethoxylated (20EO) | | |
| Tween ® 85 | Sorbitan trioleate, ethoxylated | 9005-70-3 | Croda |
| | (20EO) | | |
| Tween ® 20 | Sorbitan monolaurate, | 9005-64-5 | Croda |
| | ethoxylated (20EO) | | |
| Sunflower oil | Triglycerides from different | 8001-21-6 | |
| | C14-C18 fatty acids, | | |
| | predominantly unsaturated | | |
| Rapeseed oil | Triglycerides from different | 8002-13-9 | |
| | C14-C18 fatty acids, | | |
| | predominantly unsaturated | | |
| Corn oil | Triglycerides from different | 8001-30-7 | |
| | C14-C18 fatty acids, | | |
| | predominantly unsaturated | | |
| Soybean oil | Triglycerides from different | 8001-22-7 | |
| | C14-C18 fatty acids, | | |
| | predominantly unsaturated | | |
| Rice bran oil | Triglycerides from different | 68553-81-1 | |
| | C14-C18 fatty acids, | | |
| | predominantly unsaturated | | |
| Radia ® | ethylhexyl palmitate | 29806-73-3 | Oleon NV, BE |
| 7129 | | | Croda, UK |
| Crodamol ® | | | |
| OP | | | |
| Radia ® | ethylhexyl oleate | 26399-02-0 | Oleon NV, BE |
| 7331 | | | |
| Radia ® | ethylhexyl myristate/laurate | 29806-75-5 | Oleon NV, BE |
| 7128 | C12/C14 | | |
| Radia ® | ethylhexyl laurate | 20292-08-4 | Oleon NV, BE |
| 7127 | | | |
| Radia ® | ethylhexyl caprylate/caprate | 63321-70-0 | Oleon NV, BE |
| 7126 | C8/10 | | |
| Estol ® 1514 | iso-propyl myristate | 110-27-0 | Croda |
| Radia ® | Caprylic, capric triglycerides, | 73398-61-5. | Oleon NV, BE |
| 7104 | neutral vegetable oil | 65381-09-1 | |
| Radia ® | iso-propyl palmitate | 142-91-6 | Oleon NV, BE |
| 7732 | | | Croda, UK |
| Crodamol ® | | | |
| IPM | | | |
| Radia ® | methyl oleate | 112-62-9 | Oleon NV, BE |
| 7060 | | | |
| Radia ® | methyl palmitate | 112-39-0 | Oleon NV, BE |
| 7120 | | | |
| Crodamol ® | ethyl oleate | 111-62-6 | Croda |
| EO | | | |
| AGNIQUE | Rape seed oil methyl ester | 67762-38-3. | Clariant |
| ME ® 18 | | 85586-25-0 | BASF |
| RD-F, | | | |
| Edenor ® | | | |
| MESU | | | |
| Miglyol 812 | Glycerides, mixed decanoyl | 65381-09-1 | |
| N | and octanoly | 73398-61-5 | |
| Exxsol ® | Hydrotreated light distillates | 64742-47-8 | Exxon Mobil |
| D100 | (petroleum) | | |
| Solvesso ® | Solvent naphtha (petroleum), | 64742-94-5 | ExxonMobil |
| 200ND | heavy aromatic, naphthalene | | |
| | depleted | | |
| Kristol ® | White mineral oil | 8042-47-5 | Carless |
| M14 | (petroleum), C14-C30 | | ExxonMobil |
| Marcol ® 82 | branched and linear | | Shell |
| Ondina ® | | | |
| 917 | | | |
| Exxsol ® | White mineral oil (petroleum) | 64742-46-7 | ExxonMobil |
| D130 | | | |
| Banole ® 50 | | | Total |
| Genera ®-12 | White mineral oil (petroleum) | 72623-86-0 | Total |
| Genera ®-9 | White mineral oil (petroleum) | 97862-82-3 | Total |

TABLE MAT3
Exemplified trade names of preferred wash-off reducing materials (d)

| Product | Chemical name | Tg | MFFT | Supplier |
|---|---|---|---|---|
| Atplus ® FA | Aqueous styrene | <30° C. | | Croda |
| | acrylic co-polymer | | | |
| | emulsion dispersion | | | |
| Acronal ® V215 | aqueous acrylate co- | −43° C. | | BASF |
| Acronal ® V115 | polymer dispersion | −58° C. | | |
| Acronal ® A245 | containing carboxylic | −45° C. | | |
| Acronal ® A240 | groups. | −30° C. | | |
| Acronal ® A225 | | −45° C. | | |
| Acronal ® A145 | | −45° C. | | |
| Acronal ® 500 D | aqueous acrylic co- | −13° C. | | BASF |
| Acronal ® S 201 | polymer dispersion | −25° C. | | |
| Acronal ® DS 3618 | aqueous acrylic ester | −40° C. | | BASF |
| Acronal ® 3612 | co-polymer | +12° C. | | |
| Acronal ® V212 | dispersion | −40° C. | | |
| Acronal ® DS 3502 | | +4° C. | | |
| Acronal ® S 400 | | −8° C. | | |
| Licomer ® ADH205 | aqueous acrylic ester | <30° C. | | Michelman |
| Licomer ® ADH203 | co-polymer | | | |
| | dispersion containing | | | |
| | carboxylic groups. | | | |
| Primal ® CM-160 | Aqueous acrylic | | | DOW |
| Primal ® CM-330 | copolymer emulsion | | | |
| | polymer | | | |
| Axilat ® UltraGreen | Aqueous acrylic | −15° C. | 0° C. | Synthomer |
| 5500 | emulsion polymer | | | |
| Povol ® 26/88 | Polyvinyl alcohol | | | Kuraray |

TABLE MAT4
Exemplified trade names and CAS-No’s of preferred compounds (e)
TABLE I1 Exemplified trade names and CAS-No’s of preferred compounds (e) for Insecticide
Examples

| Product | Chemical name | Cas No. | Supplier |
|---|---|---|---|
| Lucramul PS 29 | Poly(oxy-1,2-ethanediyl),. alpha.- | 104376-75-2 | Levaco |
| | phenyl-.omega. -hydroxy-, | | |
| | styrenated | | |
| Atlox ® 4913 | methyl methacrylate graft | 119724-54-8 | Croda |
| | copolymer with polyethylene | | |
| | glycol | | |
| Morwet IP | Naphthalenesulfonic acid, bis(1- | 68909-82-0 | Akzo Nobel |
| | methylethyl)-, Me derivs., sodium | | |
| | salts | | |
| Synperonic ® | block-copolymer of polyethylene | 9003-11-6 | Croda |
| PE/F127 | oxide and polypropylene oxide | | |
| Morwet D425 | Sodium naphthalene sulphonate | 577773-56-9 | Akzo Nobel, |
| | formaldehyde condensate | 68425-94-5 | Nouryon |
| | | 9008-63-3 | |
| ATLAS ® G | Oxirane, methyl-, polymer with | 9038-95-3 | Croda |
| 5000 | oxirane, monobutyl ether | | |
| Glycerin | | 56-81-5 | |
| Propylene | 1,2-Propylene glycol | 57-55-6 | |
| Glycol | | | |
| RHODOPOL ® | Polysaccharide | 11138-66-2 | Solvay |
| 23 | | | |
| Sipernat 22 S | synthetic amorphous silica | 112926-00-8 | Evonik |
| | (silicon dioxide) | 7631-86-9 | |
| Veegum R | Smectite-group minerals | 12199-37-0 | |
| SILCOLAPSE ® | Polydimethylsiloxanes and silica | 9016-00-6 | BLUESTAR |
| 426R | | | SILICONES |
| SAG ® 1572 | Dimethyl siloxanes and silicones | 63148-62-9 | Momentive |
| Citric Acid | | 77-92-9 (anhydrous); | |
| | | 5949-29-1 | |
| | | (Monohydrate) | |
| Proxel ® GXL | 1.2-benzisothiazol-3(2H)-one | 2634-33-5 | Arch Chemicals |
| Kathon ® | 5-chloro-2-methyl-4-isothiazolin- | 26172-55-4 plus | Dow |
| CG/ICP | 3-one plus 2-methyl-4- | 2682-20-4 | |
| | isothiazolin-3-one | | |

TABLE MAT5
Exemplified trade names and CAS-No’s of preferred compounds (e)

| Product | Chemical name | Cas No. | Supplier |
|---|---|---|---|
| Morwet ® D425 | Naphthalene sulphonate | 9008-63-3 | New XX |
| | formaldehyde condensate Na salt | | |
| Synperonic ® | block-copolymer of polyethylene | 9003-11-6 | Croda |
| PE/F127 | oxide and polypropylene oxide | | |
| Synperonic ® A7 | alcohol ethoxylate (C12/C15-EO7) | 68131-39-5 | Croda |
| Xanthan | Polysaccharide | 11138-66-2 | |
| Proxel ® GXL | 1.2-benzisothiazol-3(2H)-one | 2634-33-5 | Arch Chemicals |
| Kathon ® CG/ICP | 5-chloro-2-methyl-4-isothiazolin-3- | 26172-55-4 plus | Dow |
| | one plus 2-methyl-4-isothiazolin-3- | 2682-20-4 | |
| | one | | |
| Propylene glycol | 1,2-Propylene glycol | 57-55-6 | |
| SAG ® 1572 | Dimethyl siloxanes and silicones | 63148-62-9 | Momentive |
| Atlox ® 4913 | methyl methacrylate graft | 119724-54-8 | Croda |
| | copolymer with polyethylene glycol | | |
| ATLAS ® G 5000 | Oxirane, methyl-, polymer with | 9038-95-3 | Croda |
| | oxirane, monobutyl ether | | |
| SILCOLAPSE ® 454 | Polydimethylsiloxanes and silica | 9016-00-6 | BLUESTAR |
| | | | SILICONES |
| RHODOPOL ® 23 | Polysaccharide | 11138-66-2 | Solvay |
| ACTICIDE ® MBS | Mixture of 2-methyl-4-isothiazolin- | 2682-20-4 | Thor GmbH |
| | 3-one (MIT) and 1,2- | 2634-33-5 | |
| | benzisothiazolin-3-one (BIT) in | | |
| | water | | |
| Sokalan ® K 30 | Polyvinylpyrrolidone | 9003-39-8 | BASF |
| Supragil ® WP | Sodium diisopropyl naphthalene | 1322-93-6 | Solvay |
| | sulfonate | | |
| Morwet ® D-425 | Sodium naphthalene sulphonate | 577773-56-9 | Akzo Nobel, |
| | formaldehyde condensate | 68425-94-5 | Nouryon |
| | | 9008-63-3 | |
| Soprophor ® 4 D 384 | Tristyrylphenol ethoxylate sulfate | 119432-41-6 | Solvay |
| | (16 EO) ammonium salt | | |
| Rhodorsil ® Antim | absorbed polydimethyl siloxane | unknown | Solvay |
| EP 6703 | antifoam | | |
| Kaolin Tec 1 | Aluminiumhydrosilicate | 1318-74-7 | Ziegler & Co. |
| | | 1332-58-7 | GmbH |
| Sipernat ® 22 S | synthetic amorphous silica (silicon | 112926-00-8 | Evonik |
| | dioxide) | 7631-86-9 | |
| RHODACAL ® 60 | Calcium- | 26264-06-2 | Solvay |
| BE | dodecylbenzenesulphonate in 2- | 104-76-7 | |
| | Ethylhexanol | | |
| Emulsogen ® EL 400 | Ethoxylated Castor Oil with 40 EO | 61791-12-6 | Clariant |
| Solvesso ® 200ND | Mixture of aromatic hydrocarbons | 64742-94-5 | ExxonMobil |
| | (C9-C11), naphtalene depleted | | |

### FUNGICIDES EXAMPLES

### Example FN1: Trifloxystrobin 20 SC

TABLE FN1
Recipes FN1 and FN2.

| | | | Recipe FN2 |
|---|---|---|---|
| | | Recipe FN1 | according to the |
| Component (g/l) | | reference | invention |
| Trifloxystrobin | (a) | 20.0 | 20.0 |
| Morwet ® D425 | (d) | 2.0 | 2.0 |
| Synperonic ® PE/F127 | (d) | 5.0 | 5.0 |
| Silwet ® 806 | (b) | 0 | 60.0 |
| Lucramol ® Hot 5902 | (c) | 0 | 100.0 |
| Xanthan | (d) | 3.0 | 3.0 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 2.0 | 2.0 |
| NaH₂PO₄ | (d) | 1.5 | 1.5 |
| (Buffer solution pH = 7) | | | |
| NaH₂PO₄ | (d) | 0.8 | 0.8 |
| (Buffer solution pH = 7) | | | |
| Water (add to 1 litre) | (d) | To volume | To volume |
| | | (~913) | (~753) |

The method of preparation used was according to Method 1.

Greenhouse

TABLE FN2
Biological efficacy on soybean

| | | | | Recipe FN2 |
|---|---|---|---|---|
| Spray | | | Recipe FN1 | according to the |
| volume | Rate of SC | Rate of | reference | invention |
| l/ha | applied l/ha | a.i. g/ha | Efficacy [%] | Efficacy [%] |
| 200 | 0.25 | 5 | 56 | 80 |
| 200 | 0.05 | 1 | 17 | 24 |
| 10 | 0.25 | 5 | 14 | 78 |
| 10 | 0.05 | 1 | 0 | 32 |

Method 11: soybean, 1 day preventive, evaluation 7 days after infestation

Example: The results show that recipe FN2 illustrative of the invention shows higher efficacy at both 200 l/ha and 10 l/ha spray volumes than the reference recipe FN1 without the spreading agent.

Pipette Spreading Tests on Leaves

The leaf deposit size was determined according to method 5 (b) (2 μL droplet).

TABLE FN3
Spray dilution droplet size and dose on non-textured apple leaves and
textured soybean and rice leaves.

| | | | | | High- |
|---|---|---|---|---|---|
| | Deposit | Deposit | Deposit | High- | spreading |
| | area | area | area | spreading | agent dose in |
| | mm\hat{ }2 | mm\hat{ }2 | mm\hat{ }2 | agent dose | spray liquid |
| Recipe | apple | soybean | Rice | g/ha | % w/v |
| Recipe FN1 not | 4.14 | 1.68 | 1.75 | 0 | 0 |
| according to the | | | | | |
| invention-10 l/ha | | | | | |
| Recipe FN1 not | 3.26 | 1.69 | 2.04 | 0 | 0 |
| according to the | | | | | |
| invention-200 l/ha | | | | | |
| Recipe FN2 | 14.11 | 218.0 | 167.3 | 60 | 0.6 |
| according to the | | | | | |
| invention-10 l/ha | | | | | |
| Recipe FN2 | | | | | |
| according to the | 14.02 | 27.45 | 18.29 | 60 | 0.03 |
| invention-200 l/ha | | | | | |

Formulations applied at 1.0 l/ha.

The results show that recipe FN2 illustrative of the invention shows greater deposit sizes compared to the reference recipe FN 1. The effect is greater at 10 l/ha than 200 l/ha, and greater on textured soybean and rice leaves.

### Example FN2: Prothioconazole 20 SC

TABLE FN4
Recipes FN3 and FN4.

| | | | Recipe FN4 |
|---|---|---|---|
| | | Recipe FN3 | according to the |
| | | reference | invention |
| Prothioconazole | (a) | 20.0 | 20.0 |
| Morwet ® D425 | (d) | 2.0 | 2.0 |
| Synperonic ® PE/F127 | (d) | 5.0 | 5.0 |
| Silwet ® 806 | (b) | 0 | 45.0 |
| Synperonic ® A7 | (c) | 0 | 80.0 |
| Xanthan | (d) | 3.0 | 3.0 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 2.0 | 5.0 |
| NaH₂PO₄ | (d) | 1.5 | 1.5 |
| (Buffer solution pH = 7) | | | |
| NaH₂PO₄ | (d) | 0.8 | 0.8 |
| (Buffer solution pH = 7) | | | |
| Water (add to 1 litre) | (d) | To volume | To volume |
| | | (~913) | (~785) |

The method of preparation used was according to Method 1.

Greenhouse

TABLE FN5
Biological efficacy on PHAKPA/soybean

| | | | | Recipe FN4 |
|---|---|---|---|---|
| | | | | according |
| | | | Recipe FN3 | to the |
| Spray volume | Rate of SC | Rate of | reference | invention |
| l/ha | applied l/ha | a.i. g/ha | Efficacy [%] | Efficacy [%] |
| 200 | 0.05 | 1 | 37 | 89 |
| 200 | 0.025 | 0.5 | 19 | 57 |
| 15 | 0.05 | 1 | 41 | 48 |
| 15 | 0.025 | 0.5 | 18 | 26 |

Method 11: soybean, 1 day preventive, evaluation 7 days after infestation.

The results show that recipe FN4 illustrative of the invention shows higher efficacy at 15 l/ha spray volume than the reference recipe FN3. Furthermore, recipe FN4 shows higher efficacy at 15 l/ha than recipe FN3 at 200 l/ha.

### Example FN3 Inpyrfluxam 25 SC

TABLE FN6
Recipes FN5 and FN6.

| | | | Recipe FN6 |
|---|---|---|---|
| | | Recipe FN5 | according to the |
| Component (g/l) | | reference | invention |
| Inpyrfluxam | (a) | 25.0 | 25.0 |
| Morwet ® D425 | (d) | 5.0 | 5.0 |
| Atlox ® 4913 | (d) | 10.0 | 10.0 |
| Synperonic ® PE/F127 | (d) | 5.0 | 5.0 |
| Silwet ® 806 | (b) | 0 | 75.0 |
| Crovol ® CR70G | (c) | 0 | 50.0 |
| Xanthan | (d) | 3.6 | 3.6 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 6.0 | 6.0 |
| NaH₂PO₄ | (d) | 1.5 | 1.5 |
| (Buffer solution pH = 7) | | | |
| NaH₂PO₄ | (d) | 0.8 | 0.8 |
| (Buffer solution pH = 7) | | | |
| Water (add to 1 litre) | (d) | To volume | To volume |
| | | (~901) | (~776) |

The method of preparation used was according to Method 1.

Pipette Spreading Tests on Leaves

The leaf deposit size was determined according to method 5 (b) (2 μL droplet).

TABLE FN7
Spray dilution droplet size and dose on non-textured apple leaves
and textured soybean and rice leaves.

| | | | | High- | High- |
|---|---|---|---|---|---|
| | Deposit | Deposit | Deposit | spreading | spreading |
| | area | area | area | agent | agent dose in |
| | mm\hat{ }2 | mm\hat{ }2 | mm\hat{ }2 | dose | spray liquid |
| Recipe | apple | soybean | rice | g/ha | % w/v |
| Recipe FN5 not | 7.28 | 2.27 | 1.75 | 0 | 0 |
| according to the | | | | | |
| invention-10 l/ha | | | | | |
| Recipe FN5 not | 4.74 | 3.74 | 2.46 | 0 | 0 |
| according to the | | | | | |
| invention-200 l/ha | | | | | |
| Recipe FN5 not | 3.20 | 1.34 | 2.61 | 0 | 0 |
| according to the | | | | | |
| invention-800 l/ha | | | | | |
| Recipe FN6 | 26.0 | 174.5 | 133.3 | 75 | 0.75 |
| according to the | | | | | |
| invention-10 1/ha | | | | | |
| Recipe FN6 | 24.1 | 92.3 | 48.6 | 75 | 0.0375 |
| according to the | | | | | |
| invention-200 l/ha | | | | | |
| Recipe FN6 | 13.4 | 28.4 | 18.0 | 75 | 0.0094 |
| according to the | | | | | |
| invention-800 l/ha | | | | | |

Formulations applied at 1 l/ha.

The results show that recipe FN6 illustrative of the invention shows greater coverage and larger deposit sizes at 10 L/ha spray volume than at 200 L/ha and also compared to the reference recipe FN5.

### Example FN4 Inpyrfluxam 100 SC

TABLE FN8
Recipes FN7 and FN8.

| | | | Recipe FN8 |
|---|---|---|---|
| | | Recipe FN7 | according to the |
| Component (g/l) | | reference | invention |
| Inpyrfluxam | (a) | 100.0 | 100.0 |
| Morwet ® D425 | (d) | 5.0 | 5.0 |
| Atlox ® 4913 | (d) | 10.0 | 10.0 |
| Synperonic ® PE/F127 | (d) | 5.0 | 5.0 |
| Silwet ® 806 | (b) | 0 | 50.0 |
| Alkamuls ® A | (c) | 0 | 80.0 |
| Xanthan | (d) | 3.6 | 3.6 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 6.0 | 6.0 |
| NaH₂PO₄ | (d) | 1.5 | 1.5 |
| (Buffer solution pH = 7) | | | |
| NaH₂PO₄ | (d) | 0.8 | 0.8 |
| (Buffer solution pH = 7) | | | |
| Water (add to 1 litre) | (d) | To volume | To volume |
| | | (~866) | (~736) |

The method of preparation used was according to Method 1.

Cuticle Penetration

The penetration through apple leaf cuticles was determined according to cuticle penetration test method 12.

TABLE FN9
Cuticle penetration for inpyrfluxam SC formulations.

| | Pene- | Pene- | Uptake | Uptake enhancing |
|---|---|---|---|---|
| | tration | tration | enhancing | surfactant dose |
| | % | % | surfactant | in spray |
| Recipe | 24h | 48h | dose g/ha | liquid % w/v |
| Recipe FN7 not | 17.0 | 46.9 | 0 | 0 |
| according to the | | | | |
| invention-10 l/ha | | | | |
| Recipe FN7 not | 24.0 | 50.7 | 0 | 0 |
| according to the | | | | |
| invention-200 l/ha | | | | |
| Recipe FN8 | 66.3 | 85.3 | 40 | 0.4 |
| according to the | | | | |
| invention-10 l/ha | | | | |
| Recipe FN8 | 40.9 | 57.8 | 40 | 0.02 |
| according to the | | | | |
| invention-200 l/ha | | | | |

Formulations tested at 0.5 l/ha.

The results show that recipe FN8 illustrative of the invention has a higher cuticle penetration at 10 l/ha than at 200 l/ha, and also greater than the reference recipe FN7 at both 10 l/ha and 200 l/ha.

These results demonstrate that the combination of high-spreading formulation additives and uptake enhancing additives according to the invention deliver both enhanced spreading and coverage on the target crop leaves and enhanced uptake of active ingredient into the leaves at low spray volumes.

### Example FN5 Isoflucypram 50 SC

TABLE FN10
Recipes FN9 and FN10.

| | | | Recipe FN10 |
|---|---|---|---|
| | | Recipe FN9 | according to the |
| Component (g/l) | | reference | invention |
| Isoflucypram | (a) | 50.0 | 50.0 |
| Morwet ® D425 | (d) | 10.0 | 10.0 |
| Soprophor ® FLK | (d) | 20.0 | 20.0 |
| Synperonic ® PE/F127 | (d) | 10.0 | 10.0 |
| Break-Thru ® Vibrant | (b) | 0.0 | 80.0 |
| Crovol ® CR70G | (c) | 0.0 | 80.0 |
| Xanthan | (d) | 3.0 | 3.0 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 6.0 | 6.0 |
| NaH₂PO₄ | (d) | 1.5 | 1.5 |
| (Buffer solution pH = 7) | | | |
| NaH₂PO₄ | (d) | 0.8 | 0.8 |
| (Buffer solution pH = 7) | | | |
| Water (add to 1 litre) | (d) | To volume | To volume |
| | | (~896) | (~736) |

The method of preparation used was according to Method 1.

Pipette Spreading Tests on Leaves

The leaf deposit size was determined according to method 5 (b) (2 μL droplet).

TABLE FN 11
Spray dilution droplet size and dose on non-textured apple leaves and
textured soybean and rice leaves.

| | | | | | High- |
|---|---|---|---|---|---|
| | Deposit | Deposit | Deposit | High- | spreading |
| | area | area | area | spreading | agent dose in |
| | mm\hat{ }2 | mm\hat{ }2 | mm\hat{ }2 | agent dose | spray liquid |
| Recipe | apple | soybean | rice | g/ha | % w/v |
| Recipe FN9 not | 5.12 | 2.45 | 1.14 | 0 | 0 |
| according to the | | | | | |
| invention-10 l/ha | | | | | |
| Recipe FN9 not | 5.50 | 2.84 | 1.79 | 0 | 0 |
| according to the | | | | | |
| invention-200 l/ha | | | | | |
| Recipe FN10 | 7.47 | 10.64 | 106.2 | 40 | 0.4 |
| according to the | | | | | |
| invention-10 l/ha | | | | | |
| Recipe FN10 | 4.57 | 6.64 | 9.40 | 40 | 0.02 |
| according to the | | | | | |
| invention-200 l/ha | | | | | |

Formulations applied at 0.5 l/ha.

The results show that recipe FN 10 illustrative of the invention shows significantly greater deposit sizes on textured leaves, especially rice, at 10 L/ha spray volume than at 200 L/ha and also compared to the reference recipe FN9.

### Example FN6: Fluopicolide 100 SC

TABLE FN12
Recipes FN11 and FN12.

| | | | Recipe FN12 |
|---|---|---|---|
| | | Recipe FN11 | according to the |
| Component (g/l) | | reference | invention |
| Fluopicolide | (a) | 100.0 | 100.0 |
| Morwet ® D425 | (d) | 10.0 | 10.0 |
| Soprophor ® FLK | (d) | 20.0 | 20.0 |
| Synperonic ® PE/F127 | (d) | 10.0 | 10.0 |
| Silwet ® 408 | (b) | 0.0 | 40.0 |
| Crovol ® CR70G | (c) | 0.0 | 60.0 |
| Xanthan | (d) | 3.0 | 3.0 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 6.0 | 6.0 |
| NaH₂PO₄ | (d) | 1.5 | 1.5 |
| (Buffer solution pH = 7) | | | |
| NaH₂PO₄ | (d) | 0.8 | 0.8 |
| (Buffer solution pH = 7) | | | |
| Water (add to 1 litre) | (d) | To volume | To volume |
| | | (~846) | (~746) |

The method of preparation used was according to Method 1.

Pipette Spreading Tests on Leaves

The leaf deposit size was determined according to method 5 (b) (2 μL droplet).

TABLE FN13
Spray dilution droplet size and dose on non-textured apple leaves and
textured soybean and rice leaves.

| | | | | High- | High- |
|---|---|---|---|---|---|
| | Deposit | Deposit | Deposit | spreading | spreading |
| | area | area | area | agent | agent dose in |
| | mm\hat{ }2 | mm\hat{ }2 | mm\hat{ }2 | dose | spray liquid |
| Recipe | apple | soybean | rice | g/ha | % w/v |
| Recipe FN11 not | 5.23 | 2.77 | 2.30 | 0 | 0 |
| according to the | | | | | |
| invention-10 l/ha | | | | | |
| Recipe FN11 not | 3.49 | 1.21 | 1.52 | 0 | 0 |
| according to the | | | | | |
| invention-200 l/ha | | | | | |
| RecipeFN12 | 12.31 | 176.4 | 149.4 | 40 | 0.4 |
| according to the | | | | | |
| invention-10 l/ha | | | | | |
| Recipe FN12 | 10.71 | 32.00 | 32.84 | 40 | 0.02 |
| according to the | | | | | |
| invention-200 l/ha | | | | | |

Formulations applied at 0.5 l/ha.

The results show that recipe FN12 illustrative of the invention shows greater deposit sizes compared to the reference recipe FN11. The effect is greater at 10 l/ha than 200 l/ha, and greater on textured soybean and rice leaves.

### Example FN7: Fluopyram 200 SC

TABLE FN14
Recipes FN13 and FN14.

| | | Recipe | Recipe FN14 |
|---|---|---|---|
| | | FN13 | according to |
| Component (g/l) | | reference | the invention |
| Fluopyram | (a) | 200.0 | 200.0 |
| Morwet ® D425 | (d) | 10.0 | 10.0 |
| Soprophor ® TS54 | (d) | 20.0 | 20.0 |
| Synperonic ® PE/F127 | (d) | 10.0 | 10.0 |
| Silwet ® 408 | (b) | 0.0 | 60.0 |
| Crovol ® CR70G | (c) | 0 | 80.0 |
| Xanthan | (d) | 3.0 | 3.0 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 6.0 | 6.0 |
| Na₂HPO₄ (Buffer solution | (d) | 1.5 | 1.5 |
| pH = 7) | | | |
| NaH₂PO₄ (Buffer solution | (d) | 0.8 | 0.8 |
| pH = 7) | | | |
| Water (add to 1 litre) | (d) | To volume | To volume |
| | | (~786) | (~646) |

The method of preparation used was according to Method 1.

Pipette Spreading Tests on Leaves

The leaf deposit size was determined according to method 5 (b) (2 μL droplet).

TABLE FN15
Spray dilution droplet size and dose on non-textured apple leaves and
textured soybean and rice leaves.

| | | | | | High- |
|---|---|---|---|---|---|
| | | | | | spreading |
| | | | | High- | agent |
| | Deposit | Deposit | Deposit | spreading | dose in |
| | area | area | area | agent | spray |
| | mm\hat{ }2 | mm\hat{ }2 | mm\hat{ }2 | dose | liquid |
| Recipe | apple | soybean | rice | g/ha | % w/v |
| Recipe FN13 not | 3.96 | 1.52 | 1.64 | 0 | 0 |
| according to the | | | | | |
| invention—10 l/ha | | | | | |
| RecipeFN13X not | 3.57 | 1.59 | 1.08 | 0 | 0 |
| according to the | | | | | |
| invention—200 l/ha | | | | | |
| Recipe FN14 | 18.27 | 243.9 | 151.2 | 40 | 0.4 |
| according to the | | | | | |
| invention—10 l/ha | | | | | |
| Recipe FN14 | 11.66 | 49.95 | 33.05 | 40 | 0.02 |
| according to the | | | | | |
| invention—200 l/ha | | | | | |

Formulations applied at 0.5 l/ha.

The results show that recipe FN 14 illustrative of the invention shows greater deposit sizes compared to the reference recipe FN13. The effect is greater at 10 l/ha than 200 l/ha, and greater on textured soybean and rice leaves.

### Example FN8: Fluoxapiprolin 50 SC

TABLE FN16
Recipes FN15 and FN16.

| | | Recipe | Recipe FN16 |
|---|---|---|---|
| | | FN15 | according to |
| Component (g/l) | | reference | the invention |
| Fluoxapiprolin | (a) | 50.0 | 50.0 |
| Morwet ® D425 | (d) | 10.0 | 10.0 |
| Soprophor ® TS54 | (d) | 20.0 | 20.0 |
| Synperonic ® PE/F127 | (d) | 10.0 | 10.0 |
| Agnique ® PG8107G | (b) | 80.0 | 80.0 |
| Lucramol ® HOT 5902 | (c) | 0 | 80.0 |
| Xanthan | (d) | 3.0 | 3.0 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 6.0 | 6.0 |
| Na₂HPO₄ (Buffer solution | (d) | 1.5 | 1.5 |
| pH = 7) | | | |
| NaH₂PO₄ (Buffer solution | (d) | 0.8 | 0.8 |
| pH = 7) | | | |
| Water (add to 1 litre) | (d) | To volume | To volume |
| | | (~896) | (~736) |

The method of preparation used was according to Method 1.

Pipette Spreading Tests on Leaves

The leaf deposit size was determined according to method 5 (b) (2 μL droplet).

TABLE FN17
Spray dilution droplet size and dose on non-textured apple leaves and
textured soybean and rice leaves.

| | | | | | High- |
|---|---|---|---|---|---|
| | | | | High- | spreading |
| | Deposit | Deposit | Deposit | spreading | agent dose |
| | area | area | area | agent | in spray |
| | mm\hat{ }2 | mm\hat{ }2 | mm\hat{ }2 | dose | liquid |
| Recipe | apple | soybean | rice | g/ha | % w/v |
| Recipe FN15 not | 3.68 | 2.19 | 1.69 | 0 | 0 |
| according to the | | | | | |
| invention—10 l/ha | | | | | |
| Recipe FN15 not | 3.58 | 2.24 | 2.23 | 0 | 0 |
| according to the | | | | | |
| invention—200 l/ha | | | | | |
| Recipe FN16 | 6.04 | 6.40 | 77.38 | 40 | 0.4 |
| according to the | | | | | |
| invention—10 l/ha | | | | | |
| Recipe FN16 | 5.77 | 2.54 | 8.24 | 40 | 0.02 |
| according to the | | | | | |
| invention—200 l/ha | | | | | |

Formulations applied at 0.5 l/ha.

The results show that recipe FN 16 illustrative of the invention shows greater deposit sizes compared to the reference recipe FN15. The effect is greater at 10 l/ha than 200 l/ha, and greater on textured rice leaves.

### Example FN9: Fluoxapiprolin 10 SC

TABLE FN18
Recipes FN17 and FN18.

| | | Recipe | Recipe FN18 |
|---|---|---|---|
| | | FN17 | according to |
| Component (g/l) | | reference | the invention |
| Fluoxapiprolin | (a) | 10.0 | 10.0 |
| Morwet ® D425 | (d) | 5.0 | 5.0 |
| Soprophor ® FLK | (d) | 10.0 | 10.0 |
| Synperonic ® PE/F127 | (d) | 5.0 | 5.0 |
| Silwet ® 806 | (b) | 70.0 | 70.0 |
| Alkamuls ® A | (c) | 0.0 | 70.0 |
| Xanthan | (d) | 3.0 | 3.0 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 6.0 | 6.0 |
| Na₂HPO₄ (Buffer solution | (d) | 1.5 | 1.5 |
| pH = 7) | | | |
| NaH₂PO₄ (Buffer solution | (d) | 0.8 | 0.8 |
| pH = 7) | | | |
| Water (add to 1 litre) | (d) | To volume | To volume |
| | | (~906) | (~766) |

The method of preparation used was according to Method 1.

Pipette Spreading Tests on Leaves

The leaf deposit size was determined according to method 5 (b) (2 μL droplet).

TABLE FN19
Spray dilution droplet size and dose on non-textured apple leaves and
textured soybean and rice leaves.

| | | | | High-High- |
|---|---|---|---|---|
| | | | High- | spreading |
| | Deposit | Deposit | spreading | agent dose |
| | area | area | agent | in spray |
| | mm\hat{ }2 | mm\hat{ }2 | dose | liquid |
| Recipe | apple | soybean | g/ha | % w/v |
| Recipe FN17 not | 6.15 | 4.02 | 0 | 0 |
| according to the | | | | |
| invention—10 l/ha | | | | |
| Recipe FN17 not | 4.31 | 2.95 | 0 | 0 |
| according to the | | | | |
| invention—200 l/ha | | | | |
| Recipe FN18 according | 21.00 | 149.1 | 21 | 0.21 |
| to the invention—10 l/ha | | | | |
| Recipe FN18 according | 10.43 | 26.25 | 21 | 0.0105 |
| to the invention~200 l/ha | | | | |

Formulations applied at 0.3 l/ha.

The results show that recipe FN18 illustrative of the invention shows significantly greater deposit sizes, especially on textured soybean leaves at 10 l/ha spray volume compared to 200 l/ha spray volume and also compared to the reference recipe FN17 at both 10 l/ha and 200 l/ha spray volumes.

### Example FN10: Isothianil 100 SC

TABLE FN20
Recipes FN19, Fn20 and FN21.

| | | | Recipe | Recipe |
|---|---|---|---|---|
| | | | FN20 | FN21 |
| | | Recipe | according | according |
| | | FN19 | to the | to the |
| Component (g/l) | | reference | invention | invention |
| Isothianil | (a) | 100.0 | 100.0 | 100.0 |
| Morwet ® D425 | (d) | 10.0 | 10.0 | 10.0 |
| Synperonic ® PE/F127 | (d) | 10.0 | 10.0 | 10.0 |
| Soprophor ® TS54 | (d) | 20.0 | 20.0 | 20.0 |
| Silwet ® 408 | (b) | 0.0 | 25.0 | 0.0 |
| Crovol ® CR70G | (c) | 0.0 | 80.0 | 80.0 |
| Xanthan | (d) | 3.0 | 3.0 | 3.0 |
| Proxel ® GXL | (d) | 1.5 | 1.5 | 1.5 |
| Kathon ® CG/ICP | (d) | 0.8 | 0.8 | 0.8 |
| Propylene glycol | (d) | 60.0 | 60.0 | 60.0 |
| SAG ® 1572 | (d) | 6.0 | 6.0 | 6.0 |
| Na₂HPO₄ (Buffer solution | (d) | 1.5 | 1.5 | 1.5 |
| pH = 7) | | | | |
| NaH₂PO₄ (Buffer solution | (d) | 0.8 | 0.8 | 0.8 |
| pH = 7) | | | | |
| Water (add to 1 litre) | (d) | To volume | To volume | To volume |
| | | (~846) | (~741) | (~766) |

The method of preparation used was according to Method 1.

Pipette Spreading Tests on Leaves

The leaf deposit size was determined according to method 5 (b) (2 μL droplet).

TABLE FN21
Spray dilution droplet size and dose on non-textured apple leaves and
textured soybean and rice leaves.

| | | | | | High- |
|---|---|---|---|---|---|
| | | | | | High- |
| | | | | | spreading |
| | | | | High- | agent |
| | Deposit | Deposit | Deposit | spreading | dose in |
| | area | area | area | agent | spray |
| | mm\hat{ }2 | mm\hat{ }2 | mm\hat{ }2 | dose | liquid |
| Recipe | apple | soybean | Rice | g/ha | % w/v |
| Recipe FN19 not | 3.98 | 1.72 | 2.49 | 0 | 0 |
| according to the | | | | | |
| invention—10 l/ha | | | | | |
| Recipe FN19 not | 4.67 | 1.83 | 2.38 | 0 | 0 |
| according to the | | | | | |
| invention—200 l/ha | | | | | |
| Recipe FN20 according | 8.72 | 19.45 | 60.54 | 25 | 0.25 |
| to the invention—10 | | | | | |
| l/ha | | | | | |
| Recipe FN20 according | 8.50 | 11.68 | 13.37 | 25 | 0.0125 |
| to the invention—200 | | | | | |
| l/ha | | | | | |
| Recipe FN21 not | 6.36 | 1.93 | 6.36 | 0 | 0 |
| according to the | | | | | |
| invention—10 l/ha | | | | | |
| Recipe FN21 not | 4.77 | 1.76 | 4.77 | 0 | 0 |
| according to the | | | | | |
| invention—200 l/ha | | | | | |

Formulations applied at 1.0 l/ha.

The results show that recipe FN20 illustrative of the invention shows greater deposit sizes compared to the reference recipe FN 19. The effect is greater at 10 l/ha than 200 l/ha, and greater on textured soybean and rice leaves.

### Example FN11: Tebuconazole 150 SC

TABLE FN22
Recipes FN22 and FN23.

| | | | Recipe |
|---|---|---|---|
| | | | FN23 |
| | | Recipe | according |
| | | FN22 | to the |
| Component (g/l) | | reference | invention |
| Tebuconazole | (a) | 150.0 | 150.0 |
| Morwet ® D425 | (d) | 10.0 | 10.0 |
| Synperonic ® PE/F127 | (d) | 20.0 | 20.0 |
| Soprophor ® FLK | (d) | 20.0 | 20.0 |
| Geropon ® DOS 70PG | (b) | 0.0 | 40.0 |
| Genapol ® C100 | (c) | 0.0 | 70.0 |
| Xanthan | (d) | 3.0 | 3.0 |
| Proxel ® GXL | (d) | 1.5 | 1.5 |
| Kathon ® CG/ICP | (d) | 0.8 | 0.8 |
| Propylene glycol | (d) | 60.0 | 60.0 |
| SAG ® 1572 | (d) | 6.0 | 6.0 |
| Na₂HPO₄ (Buffer solution | (d) | 1.5 | 1.5 |
| pH = 7) | | | |
| NaH₂PO₄ (Buffer solution | (d) | 0.8 | 0.8 |
| pH = 7) | | | |
| Water (add to 1 litre) | (d) | To volume | To volume |
| | | (~796) | (~686) |

The method of preparation used was according to Method 1.

Pipette Spreading Tests on Leaves

The leaf deposit size was determined according to method 5 (b) (2 μL droplet).

TABLE FN23
Spray dilution droplet size and dose on non-textured apple leaves and
textured soybean and rice leaves.

| | | | | | High- |
|---|---|---|---|---|---|
| | | | | High- | spreading |
| | Deposit | Deposit | Deposit | spreading | agent dose |
| | area | area | area | agent | in spray |
| | mm\hat{ }2 | mm\hat{ }2 | mm\hat{ }2 | dose | liquid |
| Recipe | apple | soybean | rice | g/ha | % w/v |
| Recipe FN22 not | 6.80 | 4.53 | 4.09 | 0 | 0 |
| according to the | | | | | |
| invention—10 l/ha | | | | | |
| Recipe FN22 not | 5.24 | 4.66 | 3.01 | 0 | 0 |
| according to the | | | | | |
| invention—200 l/ha | | | | | |
| Recipe FN23 | 11.08 | 36.39 | 177.3 | 40 | 0.4 |
| according to the | | | | | |
| invention—10 l/ha | | | | | |
| Recipe FN23 | 8.05 | 23.58 | 59.94 | 40 | 0.02 |
| according to the | | | | | |
| invention—200 l/ha | | | | | |

Formulations applied at 1.0 l/ha.

The results show that recipe FN23 illustrative of the invention shows greater deposit sizes compared to the reference recipe FN22. The effect is greater at 10 l/ha than 200 l/ha, and with textured leaf surfaces, especially rice.

### INSECTICIDE EXAMPLES

All examples were prepared according to the relevant methods described above

### Example I1 Spirotetramat SC Formulations

TABLE 12
Recipes Spirotetramat SC Formulations.

| Component | Recipe I1 | Recipe I2 according |
|---|---|---|
| (g/L) | reference | to the invention |
| Spirotetramat | 75 | 75 |
| Lucramul PS 29 | 40 | 40 |
| Glycerin | 100 | 100 |
| Rhodopol 23 | 3 | 3 |
| Preventol D7 | 0.8 | 0.8 |
| Proxel GXL 20% | 1.2 | 1.2 |
| Silcolapse 426R | 1 | 1 |
| Citric Acid | 1 | 1 |
| Silwet HS312 | — | 40 |
| Crovol CR70 | — | 50 |
| Water (add to 1 | To volume | To volume |
| litre) | | |

Pipette Spreading Tests on Leaves

The leaf deposit size was determined according to the coverage method 5.

TABLE 13
Spray dilution droplet size and dose on non-textured leaves.

| | | | High- |
|---|---|---|---|
| | | | spreading |
| | Deposit | Spreading | agent dose in |
| | area | agent | spray liquid |
| | mm\hat{ }2 | dose | % w/v |
| Recipe | apple | g/ha | (g/100 mL) |
| Recipe I1not according | 5.6 | 0 | 0 |
| to the invention—10 | | | |
| l/ha | | | |
| Recipe I1not according | 4.8 | 0 | 0 |
| to the invention—200 | | | |
| l/ha | | | |
| Recipe I2 according to | 7.6 | 40 | 0.4 |
| the invention—10 l/ha | | | |
| Recipe I2 according to | 5.9 | 40 | 0.02 |
| the invention—200 l/ha | | | |

Formulations applied at 1 l/ha.

The results show that on non-structured leaves the deposit size is slightly higher at lower water application volume.

TABLE 14
Spray dilution droplet size and dose on textured leaves.

| | | | High- |
|---|---|---|---|
| | | | spreading |
| | Deposit | Spreading | agent dose in |
| | area | agent | spray liquid |
| | mm\hat{ }2 | dose | % w/v |
| Recipe | soybean | g/ha | (g/100 mL) |
| Recipe I1not according | 2.6 | 0 | 0 |
| to the invention—10 | | | |
| l/ha | | | |
| Recipe I1not according | 1.2 | 0 | 0 |
| to the invention—200 | | | |
| l/ha | | | |
| Recipe I2according to | 7.4 | 40 | 0.4 |
| the invention—10 l/ha | | | |
| Recipe I2according to | 3.8 | 40 | 0.02 |
| the invention—200 l/ha | | | |

Formulations applied at 1 l/ha.

The results show that recipe I2 illustrative of the invention shows larger deposit sizes at 10 L/ha spray volume than at 200 L/ha and also compared to the reference recipe I1.

### Example I2 Tetraniliprole SC Formulations

TABLE 15
Recipes Tetraniliprole SC Formulations.

| | | Recipe 14 | | | Recipe 17 |
|---|---|---|---|---|---|
| | Recipe | according | Recipe | Recipe | according |
| Component | 13 | to the | 15 | 16 | to the |
| (g/l) | reference | invention | reference | reference | invention |
| Tetraniliprole | 40.0 | 40.0 | 80.0 | 80.0 | 80.0 |
| Atlox 4913 | 40.0 | 40.0 | 9.6 | 9.6 | 9.6 |
| Morwet IP | 10.0 | 10.0 | 2.4 | 2.4 | 2.4 |
| Synperonic | 15.0 | 15.0 | 3.6 | 3.6 | 3.6 |
| PE/F127 | | | | | |
| Citric Acid | 1.0 | 1.0 | — | — | — |
| Rhodopol 23 | 3.0 | 3.0 | 3.5 | 3.5 | 3.5 |
| Sipernat 22 S | 7.5 | 7.5 | | | |
| Silwet ® | | — | — | — | 60.0 |
| HS-312 | | | | | |
| Geropon DOS | — | 20 | — | — | — |
| RME EW 500 | — | 100 | — | — | — |
| Alkamuls A | — | — | — | 80 | 80 |
| Kathon | 0.8 | 0.8 | 0.8 | 0.8 | 0.8 |
| CG/ICP | | | | | |
| Proxel GXL | 1.2 | 1.2 | 1.8 | 1.8 | 1.8 |
| Glycerin | 100.0 | 100.0 | | | |
| Propylene | — | — | 70.0 | 70.0 | 70.0 |
| Glycol | | | | | |
| SAG1572 | 1.5 | 1.5 | 7.0 | 6.0 | 6.0 |
| Water (add to | fill | fill | fill | fill | fill |
| 1 litre) | | | | | |

Pipette Spreading Tests on Leaves

The leaf deposit size was determined according to the coverage method 5.

TABLE 16
Spray dilution droplet size and dose on non-textured leaves.

| | | | High- |
|---|---|---|---|
| | | | spreading |
| | Deposit | Spreading | agent dose in |
| | area | agent | spray liquid |
| | mm\hat{ }2 | dose | % w/v |
| Recipe | apple | g/ha | (g/100 mL) |
| Recipe 13 not | 6.7 | 0 | 0 |
| according to the | | | |
| invention—10 l/ha | | | |
| Recipe 13 not | 4.5 | 0 | 0 |
| according to the | | | |
| invention—200 l/ha | | | |
| Recipe 14 according to | 10.4 | 20 | 0.2 |
| the invention—10 l/ha | | | |
| Recipe 14 according to | 6.1 | 20 | 0.01 |
| the invention—200 l/ha | | | |

Formulations applied at 1 l/ha.

The results show that on non-structured leaves the deposit size is slightly higher at lower water application volume.

TABLE I7
Spray dilution droplet size and dose on textured leaves.

| | | | High- |
|---|---|---|---|
| | | | spreading |
| | | | agent dose in |
| | Deposit | Spreading | spray liquid |
| | area mm\hat{ }2 | agent dose | % w/v |
| Recipe | soybean | g/ha | (g/100 mL) |
| Recipe I3 not | 2.2 | 0 | 0 |
| according to the | | | |
| invention-10 l/ha | | | |
| Recipe I3 not | 1.8 | 0 | 0 |
| according to the | | | |
| invention-200 l/ha | | | |
| Recipe I4 according to | 61.5 | 20 | 0.2 |
| the invention-10 l/ha | | | |
| Recipe I4 according to | 4.7 | 20 | 0.01 |
| the invention-200l/ha | | | |

Formulations applied at 1 l/ha.

The results show that recipe I4 illustrative of the invention shows larger deposit sizes at 10 L/ha spray volume than at 200 L/ha and also compared to the reference recipe I3.

Pipette Spreading Tests on Leaves

The leaf deposit size was determined according to method 5 (b) (2 μL droplet).

TABLE I8
Spray dilution droplet size and dose on
non-textured apple leaves and textured soybean and rice leaves.

| | | | High- | High- |
|---|---|---|---|---|
| | Deposit | Deposit | spreading | spreading |
| | area | area | agent | agent dose in |
| | mm\hat{ }2 | mm\hat{ }2 | dose | spray liquid |
| Recipe | apple | soybean | g/ha | % w/v |
| Recipe I5 not | 2.4 | 1.5 | 0 | 0 |
| according to the | | | | |
| invention-10 l/ha | | | | |
| Recipe I5 not | 2.9 | 1.7 | 0 | 0 |
| according to the | | | | |
| invention-200 l/ha | | | | |
| Recipe I7 according to | 5.9 | 4.6 | 30 | 0.3 |
| the invention-10 l/ha | | | | |
| Recipe I7 according to | 5.5 | 3.0 | 30 | 0.015 |
| the invention-200 l/ha | | | | |

Formulations applied at 0.5 l/ha.

The results show that recipe I7 illustrative of the invention shows larger deposit compared to the reference recipe I5.

### Example I3 Ethiprole+Imidacloprid SC Formulations

TABLE I9
Recipes Ethiprole + Imidacloprid
SC Formulations

| | | Recipe 19 |
|---|---|---|
| | | according |
| Component | Recipe 18 | to the |
| (g/l) | reference | invention |
| Ethiprole | 100 | 100 |
| Imidacloprid | 100 | 100 |
| Morwet | 11 | 11 |
| D425 | | |
| Atlox 4913 | 69 | 69 |
| Atlas G | 22 | 22 |
| 5000 | | |
| Citric Acid | 2 | 2 |
| Rhodopol 23 | 4 | 4 |
| Veegum R | 6 | 6 |
| Break-Thru | — | 50 |
| Vibrant | | |
| Antarox | — | 50 |
| B848 | | |
| Kathon | 0.8 | 0.8 |
| CG/ICP | | |
| Proxel GXL | 1.2 | 1.2 |
| Propylene | 110 | 110 |
| Glycol | | |
| Silcolapse | 3 | 3 |
| 426R | | |
| Water (add | fill | fill |
| to 1 litre) | | |

### HERBICIDE EXAMPLES

### Example HB1: SC

TABLE HB1a
Recipes HB1, HB2, HB3 and HB4

| | Recipe | Recipe HB2 | Recipe HB3 | Recipe HB4 |
|---|---|---|---|---|
| Component | HB1 | according to | according to | according to |
| (g/l) | reference | the invention | the invention | the invention |
| TEMBOTRIONE (a) | 100.00 | 100.00 | 100.00 | 100.00 |
| ISOXADIFEN-ETHYL (a) | 50.00 | 50.00 | 50.00 | 50.00 |
| Silwet HS-604 (b) | 0.00 | 52.50 | 52.50 | 52.50 |
| Rapseed oil methylester (c) | 0.00 | 105.00 | 0.00 | 0.00 |
| Disflamoll TOF (c) | 0.00 | 0.00 | 105.00 | 0.00 |
| Genapol X-060 (c) | 0.00 | 0.00 | 0.00 | 100.00 |
| ATLAS G 5000 (d) | 10.50 | 10.50 | 10.50 | 10.50 |
| SILCOLAPSE 454 (d) | 2.10 | 2.10 | 2.10 | 2.10 |
| SYNPERONIC A7 (d) | 10.50 | 10.50 | 10.50 | 10.50 |
| ATLOX 4913 (d) | 31.50 | 31.50 | 31.50 | 31.50 |
| RHODOPOL 23 (d) | 0.18 | 0.18 | 0.18 | 0.18 |
| ACTICIDE MBS (d) | 2.10 | 2.10 | 2.10 | 2.10 |
| 1,2-PROPYLENE GLYCOL (d) | 52.50 | 52.50 | 52.50 | 52.50 |
| WATER (add to 1 litre) | to volume | to volume | to volume | to volume |

TABLE HB1b
HB5, HB6 and HB7

| | Recipe HB5 | Recipe HB6 | Recipe HB7 |
|---|---|---|---|
| Component | according to the | according to the | according to the |
| (g/l) | invention | invention | invention |
| TEMBOTRIONE (a) | 100.00 | 100.00 | 100.00 |
| ISOXADIFEN-ETHYL (a) | 50.00 | 50.00 | 50.00 |
| Geropon DOS PG (b) | 52.50 | 52.50 | 52.50 |
| Rapseed oil methylester (c) | 105.00 | 0.00 | 0.00 |
| Disflamoll TOF (c) | 0.00 | 105.00 | 0.00 |
| Genapol X-060 (c) | 0.00 | 0.00 | 100.00 |
| ATLAS G 5000 (d) | 10.50 | 10.50 | 10.50 |
| SILCOLAPSE 454 (d) | 2.10 | 2.10 | 2.10 |
| SYNPERONIC A7 (d) | 10.50 | 10.50 | 10.50 |
| ATLOX 4913 (d) | 31.50 | 31.50 | 31.50 |
| RHODOPOL 23 (d) | 0.18 | 0.18 | 0.18 |
| ACTICIDE MBS (d) | 2.10 | 2.10 | 2.10 |
| 1,2-PROPYLENE GLYCOL (d) | 52.50 | 52.50 | 52.50 |
| WATER (add to 1 litre) | to volume | to volume | to volume |

Pipette Spreading Tests on Leaves

The leaf deposit size was determined according to the coverage method 5 (b).

TABLE HB2
Spray dilution droplet size and dose on
non-textured leaves.

| | | High- | High- |
|---|---|---|---|
| | Deposit | spreading | spreading |
| | area | agent | agent dose in |
| | mm\hat{ }2 | dose | spray liquid |
| Recipe | apple | g/ha | % w/v |
| Recipe HB1 not | 7.3 | 0 | 0 |
| according to the | | | |
| invention-10 l/ha | | | |
| Recipe HB1 not | 7.1 | 0 | 0 |
| according to the | | | |
| invention-200 l/ha | | | |
| Recipe HB2 according | 7.7 | 52.5 | 0.52 |
| to the invention-10 | | | |
| l/ha | | | |
| Recipe HB2 according | 4.9 | 52.5 | 0.026 |
| to the invention-200 | | | |
| l/ha | | | |
| Recipe HB3 according | 12.4 | 52.5 | 0.52 |
| to the invention-10 | | | |
| l/ha | | | |
| Recipe HB3 according | 6.7 | 52.5 | 0.026 |
| to the invention-200 | | | |
| l/ha | | | |
| Recipe HB4 according | 9.2 | 52.5 | 0.52 |
| to the invention-10 | | | |
| l/ha | | | |
| Recipe HB4 according | 9.0 | 52.5 | 0.026 |
| to the invention-200 | | | |
| l/ha | | | |
| Recipe HB5 according | 15.4 | 52.5 | 0.52 |
| to the invention-10 | | | |
| l/ha | | | |
| Recipe HB5 according | 8.0 | 52.5 | 0.026 |
| to the invention-200 | | | |
| l/ha | | | |
| Recipe HB6 according | 22.6 | 52.5 | 0.52 |
| to the invention-10 | | | |
| l/ha | | | |
| Recipe HB6 according | 8.2 | 52.5 | 0.026 |
| to the invention-200 | | | |
| l/ha | | | |
| Recipe HB7 according | 13.2 | 52.5 | 0.52 |
| to the invention-10 | | | |
| l/ha | | | |
| Recipe HB7 according | 9.6 | 52.5 | 0.026 |
| to the invention-200 | | | |
| l/ha | | | |

Formulations applied at 1 l/ha.

The results show that on non-structured leaves the deposit size is similar or slightly higher at lower water application volume.

TABLE HB3
Spray dilution droplet size and dose on textured leaves.

| | | High- | High- |
|---|---|---|---|
| | Deposit | spreading | spreading |
| | area | agent | agent dose in |
| | mm\hat{ }2 | dose | spray liquid |
| Recipe | soybean | g/ha | % w/v |
| Recipe HB1 not | 11.7 | 0 | 0 |
| according to the | | | |
| invention-10 l/ha | | | |
| Recipe HB1 not | 4.55 | 0 | 0 |
| according to the | | | |
| invention-200 l/ha | | | |
| Recipe HB2 according | 26.7 | 52.5 | 0.52 |
| to the invention-10 | | | |
| l/ha | | | |
| Recipe HB2 according | 6.8 | 52.5 | 0.026 |
| to the invention-200 | | | |
| l/ha | | | |
| Recipe HB3 according | 38.0 | 52.5 | 0.52 |
| to the invention-10 | | | |
| l/ha | | | |
| Recipe HB3 according | 7.6 | 52.5 | 0.026 |
| to the invention-200 | | | |
| l/ha | | | |
| Recipe HB4 according | 67.1 | 52.5 | 0.52 |
| to the invention-10 | | | |
| l/ha | | | |
| Recipe HB4 according | 11.0 | 52.5 | 0.026 |
| to the invention-200 | | | |
| l/ha | | | |
| Recipe HB5 according | 66.0 | 52.5 | 0.52 |
| to the invention-10 | | | |
| l/ha | | | |
| Recipe HB5 according | 10.5 | 52.5 | 0.026 |
| to the invention-200 | | | |
| l/ha | | | |
| Recipe HB6 according | 22.4 | 52.5 | 0.52 |
| to the invention-10 | | | |
| l/ha | | | |
| Recipe HB6 according | 7.9 | 52.5 | 0.026 |
| to the invention-200 | | | |
| l/ha | | | |
| Recipe HB7 according | 41.5 | 52.5 | 0.52 |
| to the invention-10 | | | |
| l/ha | | | |
| Recipe HB7 according | 27.5 | 52.5 | 0.026 |
| to the invention-200 | | | |
| l/ha | | | |

Formulations applied at 1 l/ha.

The results show that recipes HB2-HB7 illustrative of the invention show larger deposit sizes at 10 L/ha spray volume than at 200 L/ha and also compared to the reference recipe HB1.

Cuticle Penetration

The penetration through apple leaf cuticles was determined according to cuticle penetration test method 12.

TABLE HB4
Cuticle penetration for Tembotrione SC formulations HB1-HB7.

| | | | Uptake | Uptake |
|---|---|---|---|---|
| | | | enhancing | enhancing |
| | Penetration | Penetration | surfactant | surfactant |
| | % | % | dose | dose |
| Recipe | 24 h | 37 h | g/ha | % w/v |
| Recipe HB1 not | 4.6 | 6.0 | 0 | 0 |
| according to the | | | | |
| invention-10 l/ha | | | | |
| Recipe HB1 not | 1.5 | 1.9 | 0 | 0 |
| according to the | | | | |
| invention-200 l/ha | | | | |
| Recipe HB2 according | 5.8 | 7.6 | 105 | 1.05 |
| to the invention-10 | | | | |
| l/ha | | | | |
| Recipe HB2 according | 2.1 | 2.9 | 105 | 0.05 |
| to the invention-200 | | | | |
| l/ha | | | | |
| Recipe HB3 according | 22.1 | 27.7 | 105 | 1.05 |
| to the invention-10 | | | | |
| l/ha | | | | |
| Recipe HB3 according | 6.5 | 7.7 | 105 | 0.05 |
| to the invention-200 | | | | |
| l/ha | | | | |
| Recipe HB4 according | 18.2 | 26.6 | 100 | 1.0 |
| to the invention-10 | | | | |
| l/ha | | | | |
| Recipe HB4 according | 3.3 | 5.1 | 100 | 0.05 |
| to the invention-200 | | | | |
| l/ha | | | | |
| Recipe HB5 according | 16.0 | 27.4 | 105 | 1.05 |
| to the invention-10 | | | | |
| l/ha | | | | |
| Recipe HB5 according | 19.3 | 31.0 | 105 | 0.05 |
| to the invention-200 | | | | |
| l/ha | | | | |
| Recipe HB6 according | 15.5 | 22.0 | 105 | 1.05 |
| to the invention-10 | | | | |
| l/ha | | | | |
| Recipe HB6 according | 4.8 | 8.6 | 105 | 0.05 |
| to the invention-200 | | | | |
| l/ha | | | | |
| Recipe HB7 according | 22.6 | 32.4 | 100 | 1.0 |
| to the invention-10 | | | | |
| l/ha | | | | |
| Recipe HB7 according | 20.8 | 29.7 | 100 | 0.05 |
| to the invention-200 | | | | |
| l/ha | | | | |

The results show that recipes HB2-HB7 illustrative of the invention have a higher cuticle penetration at 10 l/ha than at 200 l/ha, and also greater than the reference recipe HB1 at both 10 l/ha and 200 l/ha.

### Example HB2: SC

TABLE HB5
Recipes HB8, HB9, HB 10 and HBI 1

| | | Recipe HB9 | Recipe HB10 | Recipe HB11 |
|---|---|---|---|---|
| | Recipe HB8 | according to | according to | according to |
| Component (g/l) | reference | the invention | the invention | the invention |
| TRIAFAMONE (a) | 70.00 | 70.00 | 70.00 | 70.00 |
| Silwet L 77 (b) | 0.00 | 40.00 | 40.00 | 40.00 |
| Genapol X060 (c) | 0.00 | 60.00 | 0.00 | 0.00 |
| Disflamol TOF(c) | 0.00 | 0.00 | 60.00 | 0.00 |
| Rapseed oil methylester (c) | 0.00 | 0.00 | 0.00 | 60.00 |
| ATLOX 4913 (d) | 32.40 | 32.40 | 32.40 | 32.40 |
| ATLOX 4894 (d) | 21.60 | 21.60 | 21.60 | 21.60 |
| 1,2-PROPYLENE GLYCOL (d) | 54.00 | 54.00 | 54.00 | 54.00 |
| Silcolapse 454 (d) | 2.16 | 2.16 | 2.16 | 2.16 |
| Proxel GXL (d) | 1.94 | 1.94 | 1.94 | 1.94 |
| Kathon CG/ICP (d) | 0.86 | 0.86 | 0.86 | 0.86 |
| RHODOPOL 23 (d) | 4.32 | 4.32 | 4.32 | 4.32 |
| Na₂HPO₄ (Buffer solution pH = 7) | 1.5 | 1.5 | 1.5 | 1.5 |
| (d) | | | | |
| NaH₂PO₄ (Buffer solution pH = 7) | 0.8 | 0.8 | 0.8 | 0.8 |
| (d) | | | | |
| WATER (add to 1 litre) | to volume | to volume | to volume | to volume |

Cuticle Penetration

The penetration through apple leaf cuticles was determined according to cuticle penetration test method 12.

TABLE HB6
Cuticle penetration for Triafamone SC formulations.

| | | | Uptake | Uptake |
|---|---|---|---|---|
| | | | enhancing | enhancing |
| | | | surfactant | surfactant |
| | Penetration | Penetration | dose | dose |
| Recipe | % 12 h | % 95 h | g/ha | % w/v |
| Recipe HB8 not | 2.0 | 10.0 | 0 | 0 |
| according to the | | | | |
| invention-10 l/ha | | | | |
| Recipe HB8 not | 1.6 | 8.5 | 0 | 0 |
| according to the | | | | |
| invention-200 l/ha | | | | |
| Recipe HB9 according | 7.4 | 24.2 | 60 | 0.6 |
| to the invention-10 | | | | |
| l/ha | | | | |
| Recipe HB9 according | 6.3 | 20.8 | 60 | 0.03 |
| to the invention-200 | | | | |
| l/ha | | | | |

Formulations tested at 1 l/ha.

The results show that recipe HB9 illustrative of the invention has a higher cuticle penetration at 10 l/ha than at 200 l/ha, and also greater than the reference recipe HB8 at both 10 l/ha and 200 l/ha.

Pipette Spreading Tests on Leaves

The leaf deposit size was determined according to the coverage method 5.

TABLE HB7
Spray dilution droplet size and dose on non-textured leaves.

| | | High- | High- |
|---|---|---|---|
| | Deposit | spreading | spreading |
| | area | agent | agent dose in |
| | mm\hat{ }2 | dose | spray liquid |
| Recipe | apple | g/ha | % w/v |
| Recipe HB8 not | 9.0 | 0 | 0 |
| according to the | | | |
| invention-10 l/ha | | | |
| Recipe HB8 not | 6.5 | 0 | 0 |
| according to the | | | |
| invention-200 l/ha | | | |
| Recipe HB9 according to | 20.4 | 20 | 0.2 |
| the invention-10 l/ha | | | |
| Recipe HB9 not | 9.2 | 20 | 0.01 |
| according to the | | | |
| invention-200 l/ha | | | |
| Recipe HB10 according | 17.9 | 20 | 0.2 |
| to the invention-10 l/ha | | | |
| Recipe HB10 according | 6.0 | 20 | 0.01 |
| to the invention-200 | | | |
| l/ha | | | |
| Recipe HB11 according | 19.0 | 20 | 0.2 |
| to the invention-10 l/ha | | | |
| Recipe HB11 according | 5.4 | 20 | 0.01 |
| to the invention-200 | | | |
| l/ha | | | |

Formulations applied at 0.5 l/ha.

The results show that on non-structured leaves the deposit size is higher at lower water application volume.

TABLE HB8
Spray dilution droplet size and dose on textured leaves.

| | | High- | High- |
|---|---|---|---|
| | Deposit | spreading | spreading |
| | area | agent | agent dose in |
| | mm\hat{ }2 | dose | spray liquid |
| Recipe | soybean | g/ha | % w/v |
| Recipe HB8 not | 10.1 | 0 | 0 |
| according to the | | | |
| invention-10 l/ha | | | |
| Recipe HB8 not | 5.7 | 0 | 0 |
| according to the | | | |
| invention-200 l/ha | | | |
| Recipe HB9 according to | 81.7 | 20 | 0.2 |
| the invention-10 l/ha | | | |
| Recipe HB9 not | 10.9 | 20 | 0.01 |
| according to the | | | |
| invention-200 l/ha | | | |
| Recipe HB10 according | 69.9 | 20 | 0.2 |
| to the invention-10 l/ha | | | |
| Recipe HB10 according | 5.4 | 20 | 0.01 |
| to the invention-200 | | | |
| l/ha | | | |
| Recipe HB11 according | 73.3 | 20 | 0.2 |
| to the invention-10 l/ha | | | |
| Recipe HB11 according | 3.9 | 20 | 0.01 |
| to the invention-200 | | | |
| l/ha | | | |

Formulations applied at 0.5 l/ha.

The results show that recipes HB9, HB10 and HB11 illustrative of the invention show larger deposit sizes at 10 L/ha spray volume than at 200 L/ha, and also greater than the reference recipe HB8 at 10 l/ha and 200 l/ha.

### Example HB3: SC

TABLE HB9
Recipes HB8, HB12, HB13 and HB14

| | Recipe | Recipe HB12 | Recipe HB13 | Recipe HB14 |
|---|---|---|---|---|
| | HB8 | according to | according to | according to |
| Component (g/l) | reference | the invention | the invention | the invention |
| TRIAFAMONE (a) | 70.00 | 70.00 | 70.00 | 70.00 |
| Geropon DOS (b) | 0.00 | 50.00 | 50.00 | 50.00 |
| Genapol X060 (c) | 0.00 | 60.00 | 0.00 | 0.00 |
| Disflamol TOF (c) | 0.00 | 0.00 | 60.00 | 0.00 |
| RME (c) | 0.00 | 0.00 | 0.00 | 60.00 |
| ATLOX 4913 (d) | 32.40 | 32.40 | 32.40 | 32.40 |
| ATLOX 4894 (d) | 21.60 | 21.60 | 21.60 | 21.60 |
| 1,2-PROPYLENE GLYCOL (d) | 54.00 | 54.00 | 54.00 | 54.00 |
| Silcolapse 454 (d) | 2.16 | 2.16 | 2.16 | 2.16 |
| Proxel ® GXL (d) | 1.94 | 1.94 | 1.94 | 1.94 |
| Kathon ® CG/ICP (d) | 0.86 | 0.86 | 0.86 | 0.86 |
| RHODOPOL ® 23 (d) | 4.32 | 4.32 | 4.32 | 4.32 |
| Na₂HPO₄ (Buffer solution pH = 7) | 1.5 | 1.5 | 1.5 | 1.5 |
| (d) | | | | |
| NaH₂PO₄ (Buffer solution pH = 7) | 0.8 | 0.8 | 0.8 | 0.8 |
| (d) | | | | |
| WATER (add to 1 litre) | to volume | to volume | to volume | to volume |

Pipette Spreading Tests on Leaves

The leaf deposit size was determined according to the coverage method 5.

TABLE HB10
Spray dilution droplet size and dose on non-textured leaves.

| | | High- | High- |
|---|---|---|---|
| | Deposit | spreading | spreading |
| | area | agent | agent dose in |
| | mm\hat{ }2 | dose | spray liquid |
| Recipe | apple | g/ha | % w/v |
| Recipe HB8 not | 9.0 | 0 | 0 |
| according to the | | | |
| invention-10 l/ha | | | |
| Recipe HB8 not | 6.5 | 0 | 0 |
| according to the | | | |
| invention-200 l/ha | | | |
| Recipe HB12 according | 16.4 | 25 | 0.25 |
| to the invention-10 l/ha | | | |
| Recipe HB12 not | 8.1 | 25 | 0.013 |
| according to the | | | |
| invention-200 l/ha | | | |
| Recipe HB13 according | 11.8 | 25 | 0.25 |
| to the invention-10 l/ha | | | |
| Recipe Hb13 according | 6.5 | 25 | 0.013 |
| to the invention-200 | | | |
| l/ha | | | |
| Recipe Hb14 according | 22.8 | 25 | 0.25 |
| to the invention-10 l/ha | | | |
| Recipe HB14 according | 6.5 | 25 | 0.013 |
| to the invention-200 | | | |
| l/ha | | | |

Formulations applied at 0.5 l/ha.

The results show that on non-structured leaves the deposit size is higher at lower water application volume.

TABLE HB11
Spray dilution droplet size and dose on textured leaves.

| | | High- | High- |
|---|---|---|---|
| | Deposit | spreading | spreading |
| | area | agent | agent dose in |
| | mm\hat{ }2 | dose | spray liquid |
| Recipe | soybean | g/ha | % w/v |
| Recipe HB8 not | 10.1 | 0 | 0 |
| according to the | | | |
| invention-10 l/ha | | | |
| Recipe HB8 not | 5.7 | 0 | 0 |
| according to the | | | |
| invention-200 l/ha | | | |
| Recipe HB12 according | 65.3 | 25 | 0.25 |
| to the invention-10 l/ha | | | |
| Recipe HB12 not | 16.8 | 25 | 0.013 |
| according to the | | | |
| invention-200 l/ha | | | |
| Recipe HB13 according | — | 25 | 0.25 |
| to the invention-10 l/ha | | | |
| Recipe Hb13 according | 4.8 | 25 | 0.013 |
| to the invention-200 | | | |
| l/ha | | | |
| Recipe Hb14 according | 81.3 | 25 | 0.25 |
| to the invention-10 l/ha | | | |
| Recipe HB14 according | 3.4 | 25 | 0.013 |
| to the invention-200 | | | |
| l/ha | | | |

Formulations applied at 0.5 l/ha.

The results show that recipes HB12, HB13 and HB14 illustrative of the invention show larger deposit sizes at 10 L/ha spray volume than at 200 L/ha.

1: An agrochemical formulation comprising
a) one or more active ingredients,
b) one or more spreading agents,
c) one or uptake enhancers,
d) one formulants,
e) one or more carriers to volume,
wherein b) is present in an amount from 5 to 150 g/l.

2: An agrochemical formulation according to claim 1, wherein b) is selected from the group consisting of polyalkyleneoxide modified heptamethyltrisiloxanes and dioctylsulfosuccinate, alcohol ethoxylates, and ethoxylated diacetylene-diols with 1 to 6 EO.

3: An agrochemical formulation according to claim 1, wherein c) is selected selected from the group comprising tris (2-ethylhexyl) phosphate, rapeseed oil methyl esters, ethoxylated coconut alcohols, ethoxylated branched alcohols, propoxy-ethoxylated alcohols, ethoxylated mono- or diesters of glycerine comprising fatty acids with 8-18 carbon atoms and an average of 10-40 EO units, ethoxylated oleic acid and mineral oils.

4: An agrochemical formulation according to claim 1, wherein a) is present in an amount from 5 to 300 g/l, preferably from 10 to 250 g/l, and most preferred from 20 to 210 g/l.

5: An agrochemical formulation according to ene claim 1, wherein b) is present in an amount from 5 to 150 g/l, preferably from 10 to 120 g/l, and most preferred from 15 to 110 g/l.

6: An agrochemical formulation according to claim 1, wherein c) is present in an amount from 10 to 150 g/l, preferably from 25 to 120 g/l, and most preferred from 30 to 110 g/l.

7: An agrochemical formulation according to claim 1, wherein d) is present in an amount from 5 to 250 g/l, preferably from 10 to 150 g/l, and most preferred from 20 to 120 g/l.

8: An agrochemical formulation according to claim 1, wherein the active ingredient is selected from the group consisting of fluopicolide, fluopyram, fluoxapiprolin, inpyrfluxam, isoflucypram, isothianil, tebuconazole, trifloxystrobin, ethiprole, imidacloprid, spirotetramat, tetraniliprole, tembotrione, triafamone and isoxadifen-ethyl.

9: An agrochemical formulation according to claim 1, wherein component d) comprises at least one non-ionic surfactant and/or ionic surfactant (d1), one rheological modifier (d2), and one antifoam substance (d3) and at least one antifreeze agent (d4).

10: An agrochemical formulation according to claim 1, comprising the components a) to e) in the following amounts
a) from 5 to 300 g/l, preferably from 10 to 250 g/l, and most preferred from 20 to 210 g/l,
b) from, 5 to 150 g/l, preferably from 10 to 120 g/l, and most preferred from 15 to 110 g/l,
c) from 10 to 150 g/l, preferably from 25 to 120 g/l, and most preferred from 30 to 110 g/l,
d1) from 4 to 250 g/l, preferably from 8 to 120 g/l, and most preferred from 10 to 80 g/l,
d2) from 0 to 60 g/l, preferably from 1 to 20 g/l, and most preferred from 2 to 10 g/l,
d3) from 0 to 30 g/l, preferably from 0.5 to 20 g/l, and most preferred from 1 to 12 g/l,
d4) from 0 to 200 g/l, preferably from 5 to 150 g/l, and most preferred from 10 to 120 g/l,
d5) from 0 to 200 g/l, preferably from 0.1 to 120 g/l, and most preferred from 0.5 to 80 g/l, e) carrier to volume.

11: An agrochemical composition according to claim 1, wherein the formulation is applied at a spray volume of between 1 and 20 l/ha, preferably 2 and 15 l/ha, more preferably 5 and 15 l/ha.

12: A method of applying the agrochemical composition according to claim 1, onto crops, wherein the formulation is applied at a spray volume of between 1 and 20 l/ha, preferably 2 and 15 l/ha, and more preferably 5 and 15 l/ha.

13: The method according to claim 12, wherein the applied amount of a) to the crop is between 2 and 150 g/ha, preferably between 5 and 120 g/ha, and more preferred between 20 and 200 g/ha.

14: The method according to claim 12, wherein b) is preferably applied from 5 g/ha to 150 g/ha, more preferably from 7.5 g/ha to 100 g/ha, and most preferred from 10 g/ha to 60 g/ha.

15: The method according to claim 12, wherein the formulation is applied on plants or crops with textured leaf surfaces.

16: A method of controlling harmful organisms, comprising applying the agrochemical formulation according to claim 1, wherein the formulation is applied by an unmanned aerial vehicle (UAV), an unmanned guided vehicle (UGV), or a pulse-width-module (PWM).

17: A method of controlling harmful organisms, comprising contacting the harmful organisms, their habitat, their hosts, such as plants and seed, and the soil, the area and the environment in which they grow or could grow, but also comprising contacting materials, plants, seeds, soil, surfaces or spaces which are to be protected from attack or infestation by organisms that are harmful to plants, with an effective amount of the agrochemical formulation according to claim 1, wherein the formulation is applied by an unmanned aerial vehicle (UAV), an unmanned guided vehicle (UGV), or a pulse-width-module PWM).
